(19) United States
(12) Patent Application Publication
(10) Pub. No.: US 2012/0229719 A1
(43) Pub. Date: Sep. 13, 2012

(54) 3D DISPLAY DEVICE AND ALTERNATE-FRAME SEQUENCING MANNER 3D DISPLAY SYSTEM

(75) Inventor: Makoto ISHIGURO, Kanagawa (JP)

(73) Assignee: FUJIFILM CORPORATION, Tokyo (JP)

(21) Appl. No.: 13/416,762

(22) Filed: Mar. 9, 2012

(30) Foreign Application Priority Data
Mar. 9, 2011 (JP) 2011-051607

(51) Int. Cl. G02F 1/1335; G02F 1/137; G02B 27/22; G02B 27/26

(52) U.S. Cl. 349/15; 359/465; 359/464

(57) ABSTRACT

Disclosed is a 3D display device comprising a first polarizing film disposed at an observer-side, and a protective member, having a λ/4-function, disposed on an observer-side surface of the first polarizing film, wherein the first polarizing film is disposed so that an absorption axis thereof is along a direction of 45° or 135° with respect to a horizontal direction of a visual surface, the protective member is disposed so that a slow axis thereof is along a direction of 0° or 90° with respect to the horizontal direction of the visual surface, and an absolute value of Rth(550) of the protective member satisfies the following relation (I):

25 nm≦|Rth(550)|≦160 nm. (I)

### CROSS-REFERENCE TO RELATED APPLICATIONS

The present application claims the benefit of priority from Japanese Patent Application No. 2011-051607, filed on Mar. 9, 2011, the contents of which are herein incorporated by reference in their entirety.

### BACKGROUND OF THE INVENTION

1. Field of the Invention

The present invention relates to a 3D display device and a alternate-frame sequencing manner 3D display system.

2. Background Art

Various manners have been proposed as a three-dimensional (3D) displaying manner, and one of them is an alternate-frame sequencing manner employing liquid crystal shutter eyeglasses or the like. According to the manner, the left-eye and right-eye shutters are driven in synchronization with left-eye and right-eye images respectively while the left-eye and right-eye images are displayed alternately so as to come into the corresponding eyes respectively (for example, JP-A-53-51917). A 3D display device in this manner, employing a liquid crystal panel, has been proposed (for example, JP-A-2003-259395). The 3D display device in this manner suffers from decrease of brightness, variation of coloration and worsening of cross-talk which occur when a person observing the image inclines his/her head (hereinafter, the condition that a person observing the image inclines his/her head is occasionally referred to as “in the head-inclination-state”); and solving such problems has been required. For solving the problems of the brightness-decrease and the cross-talk-worsening, disposing a λ/4 plate on surfaces of the display device and the shutter eyeglasses respectively, that is, using circularly-polarized images, has been proposed (for example, JP-A-2002-82307).

Although it is possible to solve the problems of the brightness-decrease and the cross-talk-worsening in the head-inclination-state by using a λ/4 film, as described above, it is not possible to solve the variation of coloration merely by using a λ/4 film. The reason resides in that the wavelength dispersion characteristics of Re of the λ/4 film or Rth of the λ/4 film influence the coloration-variation phenomenon remarkably.

And there is a demand for a large-screen 3D display. For such a large-screen 3D display device, the visibility in the horizontal direction is more important than that in the vertical direction.

### SUMMARY OF THE INVENTION

As described above, the wavelength dispersion characteristics of Re of the λ/4 film or Rth of the λ/4 film are considered to influence the coloration-variation phenomenon remarkably. An ideal λ/4 film has reversed wavelength dispersion characteristics of Re and has Rth of zero. Although it is predictable that the variation of coloration would be reduced by using such an ideal λ/4 film, it is difficult and expensive to produce such an ideal λ/4 film. Especially, it is very difficult to produce an ideal λ/4 film to be used for a large screen, and therefore, it is very difficult to achieve both a large-screen size and decrease of the coloration-variation.

Therefore, one object of the present invention is to provide a 3D display device in which the variation of coloration occurring in the head-inclination-state is reduced even without an ideal λ/4 film.

Although it was predictable that the variation of the coloration in the head-inclination-state is reduced by using an ideal λ/4 film, that is, a λ/4 film having reversed wavelength dispersion characteristics of Re and Rth of zero, the present inventor conducted various studies, and as a result, found that, even if the λ/4 film of which value of Rth(550) was close to 0 nm was used, the degree of the variation of coloration became asymmetry depending on the right- or left-side from which the visual surface was observed, and also that the variation of coloration in the head-inclination-state couldn't be reduced by using such a λ/4 film. The inventor conducted further studies, and as a result, found that the directions of the absorption axis of the polarizing film and the slow axis of the λ/4 film, which were disposed in the display device, affected the variation of coloration in the head-inclination-state, and also that the variation of coloration could be reduced remarkably when the absorption axis and the slow axis were along the predetermined direction respectively and the value of Rth of the λ/4 film was the predetermined range. On the basis of this knowledge, he conducted further studies, and as a result, made the present invention. According to the invention, it is possible to achieve the above-mentioned object even without using an ideal λ/4 film, and therefore, the present invention would be suitable for practical use.

The means for achieving the above-described object are as follows.

<1> A 3D display device comprising:

a first polarizing film disposed at an observer-side, and

a protective member, having a λ/4-function, disposed on an observer-side surface of the first polarizing film, wherein

the first polarizing film is disposed so that an absorption axis thereof is along a direction of 45° or 135° with respect to a horizontal direction of a visual surface,

the protective member is disposed so that a slow axis thereof is along a direction of 0° or 90° with respect to the horizontal direction of the visual surface, and

an absolute value of retardation along the thickness direction at a wavelength of 550 nm, Rth(550), of the protective member satisfies the following relation (I):

25 nm≦|Rth(550)|≦160 nm. (I)

<2> The 3D display device of <1>, wherein the protective member is disposed so that the slow axis thereof is along a direction of 0° with respect to the horizontal direction of the visual surface, and

Rth(550) of the protective member satisfies the following relation (Ia):

25 nm≦Rth(550)≦160 nm. (Ia)

<3> The 3D display device of <1>, wherein the protective member is disposed so that the slow axis thereof is along a direction of 90° with respect to the horizontal direction of the visual surface, and

Rth(550) of the protective member satisfies the following relation (Ib):

−160 nm≦Rth(550)≦−25 nm. (Ib)

<4> The 3D display device of any one of <1>-<3>, wherein the protective member comprises a retardation layer formed of a composition comprising a liquid crystal compound.
<5> The 3D display device of <4>, wherein the liquid crystal compound is a discotic liquid crystal compound, and the discotic liquid crystal compound is aligned vertically in the retardation layer.
<6> The 3D display device of <4>, wherein the liquid crystal compound is a rod-like liquid crystal compound, and the rod-like liquid crystal compound is aligned horizontally in the retardation layer.
<7> The 3D display device of any one of <1>-<6>, wherein retardation in-plane of the protective member as a whole is constant without any dependency on a wavelength in a visible light region or has normal wavelength dispersion characteristics in a visible light region.
<8> The 3D display device of any one of <1>-<7>, wherein the protective member comprises an antireflective layer disposed at an observer-side surface thereof.
<9> The 3D display device of any one of <1>-<8>, wherein the protective member comprises an ultraviolet absorber.
<10> The 3D display device of any one of <1>-<9>, comprising a liquid crystal cell employing a TN-mode, OCB-mode or ECB-mode.
<11> An alternate-frame sequencing manner 3D displaying system comprising:

an alternate-frame sequencing manner 3D display device of any one of <1>-<10>, and

an alternate-frame sequencing shutter working in synchronization with the 3D display device.

<12> The alternate-frame sequencing manner 3D displaying system of <11>, wherein the alternate-frame sequencing shutter comprises, in the following order from a surface thereof facing the 3D display device,
a λ/4 plate,
a liquid crystal cell and
a polarizing film.
   <13> The alternate-frame sequencing manner 3D displaying system of <12>, wherein the alternate-frame sequencing shutter further comprises a polarizing film disposed between the λ/4 plate and the liquid crystal cell.

According to the invention, it is possible to provide a 3D display device in which the variation of coloration occurring in the head-inclination-state is reduced.

### BRIEF DESCRIPTION OF THE DRAWINGS

FIG. 1 is a schematic view of example of an alternate-frame sequencing manner 3D displaying system of the present invention.

FIG. 2 is a schematic cross-sectional view of one example of an alternate-frame sequencing manner 3D displaying system of the present invention.

FIGS. 3A and 3B are schematic cross-sectional views of examples of an alternate-frame sequencing manner 3D displaying system of the present invention.

FIGS. 4A, 4B, and 4C are schematic cross-sectional views of examples of a protective member or a λ/4 plate of the present invention.

FIGS. 5A, 5B, and 5C are schematic cross-sectional views of examples of a first polarizing plate.

FIGS. 6A, 6B, and 6C are schematic cross-sectional views of examples of a first polarizing plate.

FIG. 7 is a schematic cross-sectional view of one example of an alternate-frame sequencing manner 3D displaying system of the present invention.

In the drawings, the meanings of the reference numerals are as follows:
1 Display device
11 First polarizing film
12 Protective member
13 Liquid crystal cell
14 Polarizing plate
15 Optical compensation film/Protective film
2 Alternate-frame sequencing shutter (liquid crystal shutter eyeglasses)
2a Left-eye shutter
2b Right-eye shutter
21 λ/4 plate
22 Polarizing film
23 Liquid crystal cell
24 Polarizing film
3 Synchronizing circuit
4 Backlight

### DETAILED DESCRIPTION OF THE INVENTION

The present invention is described in detail by showing some embodiments thereof. In this description, the numerical range expressed by the wording “a number to another number” means the range that falls between the former number indicating the lower limit of the range and the latter number indicating the upper limit thereof.

At first, the terms to be used in the description will be explained.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program. When a film to be analyzed is expressed by a monoaxial or biaxial index ellipsoid, Rth(λ) of the film is calculated as follows.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21 ADH or WR, as an inclination axis (a rotation axis; defined in an arbitrary in-plane direction if the film has no slow axis in plane), a value of hypothetical mean refractive index, and a value entered as a thickness value of the film. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination axis (rotation axis) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} … \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth=((nx+ny)/2−nz)×d (B)

When the film to be analyzed is not expressed by a monoaxial or biaxial index ellipsoid, or that is, when the film does not have an optical axis, then Rth(λ) of the film may be calculated as follows: Re(λ) of the film is measured around the slow axis (decided by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR. In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In this description, the correlation between optical axes includes errors acceptable in the technical field to which the invention belongs. Concretely, “parallel” and “orthogonal” is meant to fall within a range of less than the strict angle ±10°, preferably within a range of less than the strict angle ±5°, more preferably within a range of less than the strict angle°±2°. The angle of the slow axis or the absorption axis is meant to fall within a range of less than the strict angle ±5°. The error from the strict angle is preferably less than ±5°, or more preferably less than ±2°. More specifically, the description “the slow axis is 0°” means that the slow axis falls within the range of from −5° to 5°; and the description “the slow axis is 90°” means that the slow axis falls within the range of from 85° to 95°. The description “the absorption axis is 45°” means that the absorption axis falls within the range of from 40° to 50°; and the description “the absorption axis is 135°” means that the absorption axis falls within the range of from 130° to 140°. “Slow axis” means the direction in which the refractive index is the largest.

Unless specifically indicated, the wavelength at which the refractive index is measured is 550 nm in a visible light region; and unless specifically indicated, as well as the wavelength for the refractive index, the wavelength for measuring Re or Rth is 550 nm.

In this description, “polarizing film” and “polarizing plate” are used as differentiated, and “polarizing plate” means a laminate having, on at least one side of “polarizing film”, a transparent protective film to protect the polarizing film. The transparent protective film is any self-supporting film disposed between a liquid crystal cell and a polarizing film, and the definition of the transparent protective film has no relation with the retardation value. And in the specification, the term “λ/4 plate” is used as a same meaning as the term “λ/4 film”.

In the description, 0° on the visual surface of a 3D displaying device is defined as the direction parallel to the ground surface; the counterclockwise direction relative to the horizontal direction is defined as a positive direction (“+”); and the clockwise direction relative to the horizontal direction is defined as a negative direction (“−”);

Embodiments of the 3D displaying device of the invention are described in detail below with reference to the drawings. FIG. 1 is a schematic view of example of an alternate-frame sequencing manner 3D displaying system of the present invention. The alternate-frame sequencing manner 3D displaying system shown in FIG. 1 comprises a display device 1 and eyeglasses 2 (an alternate-frame sequencing shutter) having a shutter-function, and the images displayed on the display device 1 are observed by a person wearing the eyeglasses 2. Although not shown in FIG. 1, the display device 1 has a polarizing film and a protective member having a λ/-function which are disposed at the visual surface side thereof, and circular-light images are displayed on the display device 1 for the observer, and the eyeglasses 2 also contains a λ/4 plate and has a shutter-function of switching on/off for the transmission of circular light.

Left-eye and right-eye images may be displayed alternately on the display device 1 at prescribed frequency (e.g., 60 Hz or more). According to an embodiment, image signals are processed into left-eye and right-eye image signals in an image processing section, and sent to a drive circuit for a display monitor. Then the left-eye and right-eye image signals are assigned alternately to each of the pixels in the display device 1 with respect to each field, so that left-eye and right-eye images are displayed alternately on the same visual surface of the display device 1 at a prescribed time-interval and are converted to left-eye and right-eye circular light images by a polarizing film and a protective member having a λ/4-function.

Working in synchronization with the display device 1 via a synchronizing circuit 3, the eyeglass 2 may be provided with drive voltage or the like. More specifically, when left-eye images are displayed, the left-eye shutter 2a has a maximum transmittance of circular light, which allows the images to come into the left-eye; and the right-eye shutter 2b has a minimum transmittance of circular light, which does not allow the images to come into the right-eye. On the other hand, when right-eye images are displayed, the right-eye shutter 2b has a maximum transmittance of circular light, which allows the images to come into the right-eye; and the left-eye shutter 2a has a minimum transmittance of circular light, which does not allow the images to come into the left-eye. The observer can recognize the displayed images as stereo images by watching the left-eye images via only the left eye selectively and watching the right-eye images via only the right-eye selectively. It is to be noted that the mechanism of switching on/off is not limited. Eyeglasses employing a shutter mechanism of a liquid crystal cell are preferable.

As described above, a polarizing film and a λ/4-function protective member are disposed at the visual surface of the display device 1, so that circular light images can be displayed for an observer; and the eyeglasses 2 also contains a λ/4 plate and has a shutter-function of switching on/off for the transmission of circular light. Conventionally, according to an alternate-frame sequencing manner 3D displaying system employing, it has been possible to solve the problems of the brightness-decrease and the cross-talk-worsening in the head-inclination-state by using a λ/4 film, but it has not been possible to solve the variation of coloration merely by using a λ/4 film. According to the invention, it is possible to reduce the variation of coloration in the head-inclination-state by disposing the polarizing film so that the absorption axis thereof is along a direction of 45° or 135° with respect to a horizontal direction of the visual surface, disposing the protective member so that the slow axis thereof is along a direction of 0° or 90° with respect to the horizontal direction of the visual surface, and using the member having Rth satisfying the following relation (I) as the λ/4-function protective member.

25 nm≦|Rth(550)|≦160 nm. (I)

Conventionally, the variation of coloration in the head-inclination-state has been considered to be more reduced by using an ideal λ/4 film, that is, by making the value of Rth closer to 0. Under such a circumstance, it is not predictable that the present invention brings about the same or superior effect compared with that using an ideal λ/4 film of which Rth is zero.

The construction of the display device 1 is not limited. Examples thereof include liquid crystal panels containing a liquid crystal layer and organic EL panels containing an organic EL layer. Any constructions proposed for each embodiment of the panel may be selected. And the shutter mechanism of the eyeglasses is not limited, and any constructions provided for the eyeglasses may be selected. Eyeglasses employing a shutter mechanism of a liquid crystal cell are preferable.

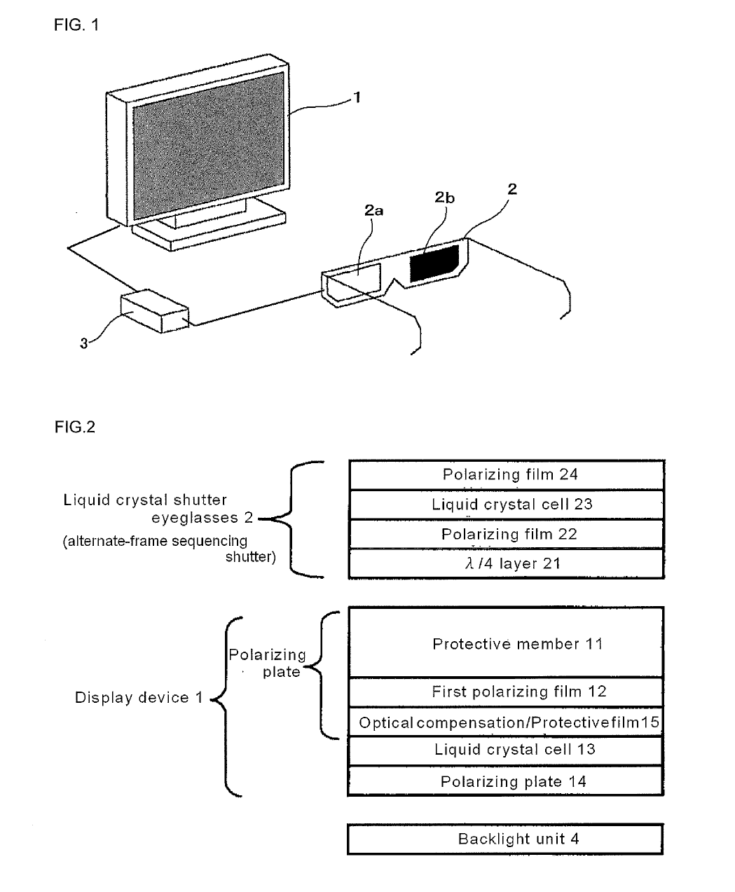

FIG. 2 is a schematic cross-sectional view of one example of an alternate-frame sequencing manner 3D displaying system of the present invention. The example shown in FIG. 2 contains a liquid-crystal panel as the display device 1 and liquid-crystal shutter eyeglasses as the eyeglasses 2. It is to be noted that the relative relation in thickness between one layer and another layer shown in the drawing is not always same as the actual relative relation in a display device.

The display device 1 is a liquid-crystal panel comprising a liquid crystal cell 13, a first polarizing film 12 disposed at an observer-side, and a protective member 11 disposed on an observer-side surface of the first polarizing film 12. The liquid-crystal shutter eyeglasses 2 comprise a liquid crystal cell 23 and a λ/4 film 21. The protective member 11 has a λ/4-function.

A backlight 4 is disposed at the rear-side of the liquid crystal cell 13 in the display device, a polarizing plate 14 is disposed between the backlight 4 and the liquid crystal cell 13, and the display device 1 is constructed as a transmissive one. The absorption axis of the polarizing plate 14 is orthogonal to the absorption axis of the first polarizing film 12. For optically compensating the viewing angle characteristics and/or protecting the polarizing film 12, a film 15 is disposed between the first polarizing film 12 and the liquid crystal cell 13. The polarizing plate 14 may have a protective film on the surfaces of the liquid crystal cell side and the backlight side respectively.

The construction of the liquid crystal cell 13 is not limited, and any liquid crystal cell having a general construction may be used. The liquid crystal cell 13 may have a pair of substrates and a liquid crystal layer between the pair of substrates, and, if necessary may have a color filter or the like. The driving mode of the liquid crystal cell 13 is not limited. According to a twisted nematic (TN), super-twisted nematic (STN) or optically compensated bend (OCB) mode, usually, the polarizing film is disposed so that the absorption angle thereof is along the direction of 45° or 135°, and therefore, by using any liquid crystal cell employing such a mode, it is possible to use the conventional construction without any modification.

The first polarizing film 12 at the visual surface side is disposed so that the absorption axis thereof is along a direction of 45° or 135° with respect to a horizontal direction of the visual surface. And the first polarizing film 12 has the protective member 11 exhibiting the λ/4-function on the observer-side surface, and the protective member 11 is disposed so that the slow axis thereof is along a direction of 0° or 90° with respect to a horizontal direction of the visual surface. The construction of the protective member 11 is not limited, and any single-layer- or multilayered-construction may be selected. Examples of the protective member 11 exhibiting the λ/4-function include a retardation polymer film, a lamination of plural retardation polymer films, an optically anisotropic layer (retardation layer) formed by curing the alignment of a liquid crystal composition and a lamination of the optically anisotropic layer and a polymer film supporting the layer. The protective member 11 containing a polymer film is preferable since it may function also as a protective film of the polarizing film 12. The protective member 11 preferably has an antireflection layer on the observer-side surface thereof. These members will be described in detail later.

The absolute value of Rth(550) of the protective member 11 as a whole, which is retardation along the thickness at a wavelength of 550 nm, satisfies the following relation (I), preferably satisfies the following relation (II), or more preferably satisfies the following relation (III).

25 nm≦|Rth(550)|≦160 nm (I)

30 nm≦|Rth(550)|≦140 nm (II)

40 nm≦|Rth(550)|≦120 nm (III)

It is to be noted that Rth(550) of the protective member 11 as a whole, which is retardation along the thickness at a wavelength of 550 nm, is total retardation along the thickness-direction at 550 nm of all of the members constituting the protective member 11.

According to the embodiment, wherein the protective member 11 is disposed so that the slow axis thereof is along a direction of 0° with respect to the horizontal direction of the visual surface, Rth(550) of the protective member 11 as a whole preferably satisfies the following relation (Ia), more preferably satisfies the following relation (IIa), or even more preferably satisfies the following relation (IIIa), in terms of reducing the variation of the coloration in the horizontal direction of the visual surface.

25 nm≦Rth(550)≦160 nm (Ia)

30 nm≦Rth(550)≦140 nm (IIa)

40 nm≦Rth(550)≦120 nm (IIIa)

On the other hand, according to the embodiment, wherein the protective member 11 is disposed so that the slow axis thereof is along a direction of 90° with respect to the horizontal direction of the visual surface and has Rth(550) satisfying the relation (Ia) (more preferably the relation (IIa), or even more preferably the relation (IIIa)), it is possible to more reduce the variation of the coloration in the vertical direction of the visual surface.

According to the embodiment, wherein the protective member 11 is disposed so that the slow axis thereof is along a direction of 90° with respect to the horizontal direction of the visual surface, Rth(550) of the protective member 11 as a whole preferably satisfies the following relation (Ib), more preferably satisfies the following relation (IIb), or even more preferably satisfies the following relation (IIIb), in terms of reducing the variation of the coloration in the horizontal direction of the visual surface.

−160 nm≦Rth(550)≦−25 nm (Ib)

−140 nm≦Rth(550)≦−30 nm (IIb)

−120 nm≦Rth(550)≦−40 nm (IIIb)

On the other hand, according to the embodiment, wherein the protective member 11 is disposed so that the slow axis thereof is along a direction of 0° with respect to the horizontal direction of the visual surface and has Rth(550) satisfying the relation (Ib) (more preferably the relation (IIb), or even more preferably the relation (IIIb)), it is possible to more reduce the variation of the coloration in the vertical direction of the visual surface.

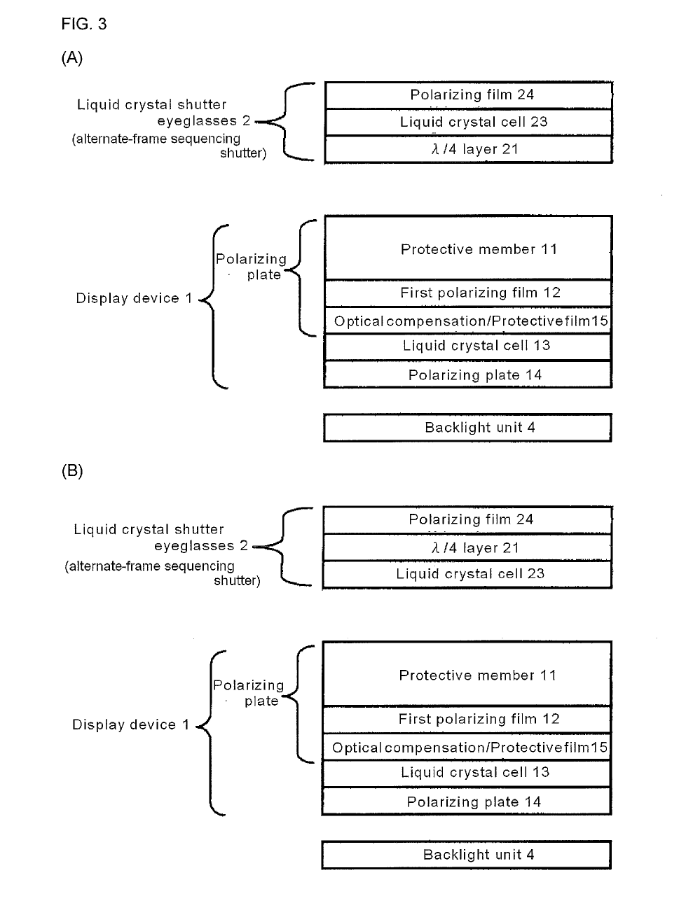

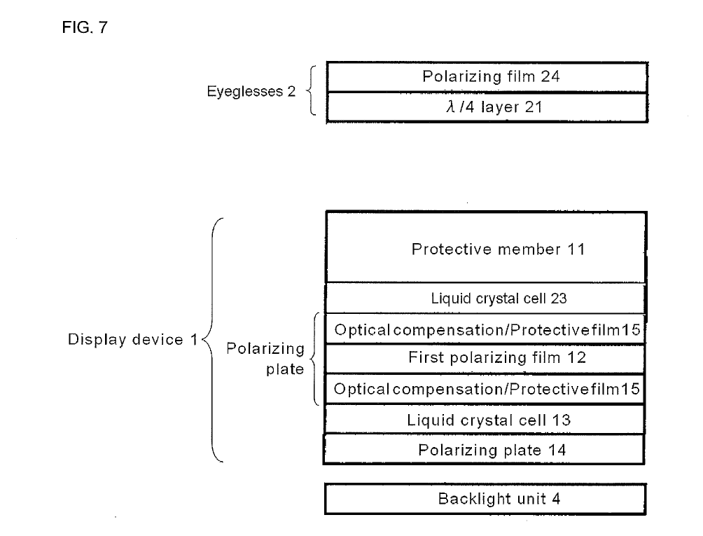

The eyeglasses 2 comprise a λ/4 plate 21, a polarizing film 22, a liquid crystal cell 23 and a polarizing film 24, and exhibit a shutter-function working in synchronization with the display device 1. As the construction of the eyeglasses 2, the manner employing two polarizing films as shown in FIG. 2 may be selected, or the manner employing a polarizing film as shown in FIG. 3(a) or 3(b) may also be used. Furthermore, a liquid crystal cell 23 may be disposed on the display device 1 as shown in FIG. 7, and the similar effect may be obtained according to such an embodiment. In this embodiment, the liquid crystal cell 23 may function as an active-retarder cell which is capable of converting the outgoing light from the display device 1 to the left- and right-circular lights in the alternate-frame sequencing manner.

The construction of the λ/4 plate 21 is not limited. Any single-layer-construction or any multilayered construction may be used. According to the embodiment wherein the observer wears it, the lighter and thinner λ/4 plate 21 is more preferable. Accordingly, any single-layer-construction is preferable. Examples of the λ/4 plate 21 include a retardation polymer film, a lamination of plural retardation polymer films, an optically anisotropic layer (retardation layer) formed by curing the alignment of a liquid crystal composition and a lamination of the optically anisotropic layer and a polymer film supporting the layer. The λ/4 plate 21 containing a polymer film is preferable since it may function also as a protective film of the polarizing film 22. The λ/4 plate 21 preferably has a hard coat layer or an antireflection layer on the observer-side surface thereof. These members will be described in detail later.

In the display device, the angle between the absorption axis of the first polarizing film 12 and the slow axis of the protective member 11 with a λ/4 function is preferably 45°±10°, that is, from 35° to 55°, or preferably 135°±10°, that is, from 125° to 145°. The absorption axis of the first polarizing film 12 is preferably orthogonal or parallel to the absorption axis of the polarizing film 22; and the slow axis of the protective member 11 is preferably orthogonal or parallel to the slow axis of the λ/4 plate.

According to the embodiment wherein the protective member 11 or the λ/4 plate 21 contains plural retardation layers and/or retardation films, the slow axis thereof is defined as the slow axis obtained by measuring the protective member 11 or the λ/4 plate 21 as a whole

The alternate-frame sequencing manner 3D displaying system of the present invention may comprise any member other than the members shown in FIG. 2, and preferable examples of such a member include an image processing section capable of processing image signals into left-eye and right-eye image signals, a drive circuit for a display monitor capable of sending the image signals to the display, and a synchronizing circuit capable of switching on/off for the transmittance of the left- and right-liquid crystal shutters by sending the signals to the liquid crystal-shutter eyeglasses depending on the image signals.

Various members to be used in the 3D display device of the invention will be described in detail below.

### 1. Member Having a λ/4-Function

According to the invention, a member having a λ/4-function is used as a protective member to be disposed on the observer-side surface of the first polarizing film which is disposed at the observer-side of the display device, or a λ/4 plate contained in the alternate-frame sequencing shutter.

In the embodiment shown in FIG. 2 or 3(a), the term “λ/4 plate” is a collective term of all of the layers which are disposed closer to the display device 1 relative to the liquid crystal cell; and in the embodiment shown in FIG. 3(b), the term “λ/4 plate” is a collective term of all of the layers which are disposed between the polarizing film and the liquid crystal cell.

According to the invention, the absolute value of Rth(550) of the protective member, which is retardation along the thickness-direction, satisfies the following relation (I):

25 nm≦|Rth(550)|≦160 nm (I)

preferably satisfies the following relation (II):

30 nm≦|Rth(550)|≦140 nm (II):

or even more preferably satisfies the following relation (III).

40 nm≦|Rth(550)|≦120 nm (III)

According to the invention, it is possible to reduce the variation of coloration in at least either of the horizontal direction or the vertical direction of the visual surface; and in the embodiment employing a large-sized screen, the effect of reducing the variation of coloration in the horizontal direction is especially important. The embodiment in which the variation of coloration in the horizontal direction of the visual surface is remarkably reduced is as follows.

According to the embodiment, wherein the protective member is disposed so that the slow axis thereof is along a direction of 0° with respect to the horizontal direction of the visual surface, Rth(550) of the protective member as a whole preferably satisfies the following relation (Ia):

25 nm≦Rth(550)≦160 nm (Ia)

more preferably satisfies the following relation (IIa):

30 nm≦Rth(550)≦140 nm (IIa)

or even more preferably satisfies the following relation (IIIa).

40 nm≦Rth(550)≦120 nm (IIIa)

According to the embodiment, the variation of coloration in the head-inclination-state can be remarkably reduced in the horizontal direction of the display surface.

According to the embodiment, wherein the protective member is disposed so that the slow axis thereof is along a direction of 90° with respect to the horizontal direction of the visual surface, Rth(550) of the protective member as a whole preferably satisfies the following relation (Ib):

−160 nm≦Rth(550)≦−25 nm (Ib)

more preferably satisfies the following relation (IIb):

−140 nm≦Rth(550)≦−30 nm (IIb)

or even more preferably satisfies the following relation (IIIb).

−120 nm≦Rth(550)≦−40 nm (IIIb)

According to the embodiment, the variation of coloration in the head-inclination-state can be remarkably reduced in the horizontal direction of the display surface.

Re(550) of the protective member, which is retardation in plane at a wavelength of 550 nm, is preferably the ideal value (137.5 nm) ±25 nm, for example, from 115 nm to 160 nm. Re (550) of the protective member is total retardation in plane at 550 nm of all of the films or layers in the protective member.

Regarding the protective member as a whole, the wavelength dispersion characteristic of retardation in plane, Re, is not limited. Re of the protective member may show the normal wavelength dispersion characteristic in which Re in the visible-light range becomes smaller at a longer wavelength, or the flat wavelength dispersion characteristic in which Re in the visible-light range is constant without any dependency on the wavelength. Namely, Re of the protective member may satisfy the relation of “Re(450) a Re(550) a Re(630)”. Generally, an ideal λ/4 plate has been considered to have Re of λ/4 at any of wavelengths of 450 nm, 550 nm and 630 nm. More specifically, an ideal λ/4 plate satisfies the conditions of Re(450)=112.5 nm, Re(550)=137.5 nm and Re(630)=157.5 nm. That is, an ideal λ/4 plate has been considered to have the reversed wavelength dispersion characteristic of Re, and the wavelength dispersion characteristic of Re apart from the ideal characteristic has been considered to be a factor of causing the variation of coloration in the horizontal direction. Accordingly, the effect of reducing the variation of coloration in the head-inclination-state, brought about by the present invention using the λ/4-function-protective member even with the normal or flat wavelength dispersion characteristic other than the ideal wavelength dispersion characteristic, is not predictable. And the scope of the polymer film or the like to be used as or in the protective member may be widened, which may be advantageous in practical use.

According to the present invention, regarding the λ/4 plate to be used in the alternate-frame sequencing shutter, the wavelength dispersion characteristic of Re is not limited. A λ/4 film having the reversed wavelength dispersion characteristic of Re is preferable.

The protective member or the λ/4 plate may have any single-layer-construction or any multilayered-construction. According to the embodiment wherein the λ/4 plate is contained in the alternate-frame sequencing shutter which the observer wears, the lighter and thinner λ/4 plate is more preferable. The protective member or the λ/4 plate containing a polymer film is preferable since it may function also as a protective film of the polarizing film. The protective member or the λ/4 plate preferably has an antireflection layer on the surface thereof. Examples of the member exhibiting the λ/4-function include a retardation polymer film, a lamination of plural retardation polymer films, an optically anisotropic layer (retardation layer) formed by curing the alignment of a liquid crystal composition and a lamination of the optically anisotropic layer and a polymer film supporting the layer. Examples of the retardation polymer film include any films exhibiting optical anisotropy prepared by stretching a polymer film so as to align the high-molecular weight molecules in the film. The member exhibiting the λ/4-function may be constructed by a single or a plurality of biaxial films, or may be constructed by two or more monoaxial films such as a combination of C-plate and A-plate. The member exhibiting the λ/4-function may be constructed also by any combination of one or more biaxial films and one or more monoaxial films. The optically anisotropic layer is a layer exhibiting optical anisotropy caused by the alignment of liquid crystal molecules. The optically anisotropic layer alone may have a λ/4-function, or may have a λ/4-function along with the polymer film supporting the layer as a combination.

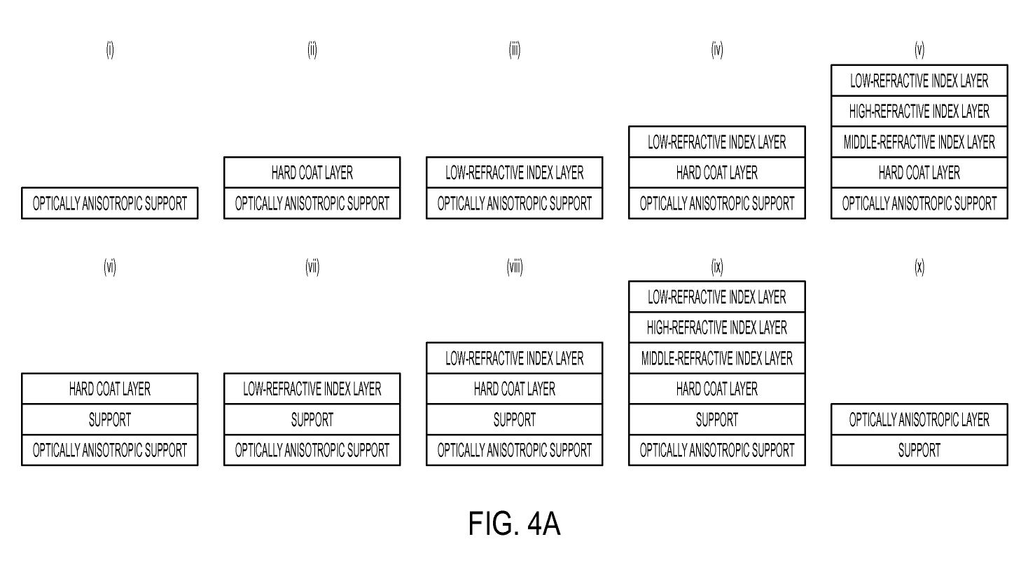

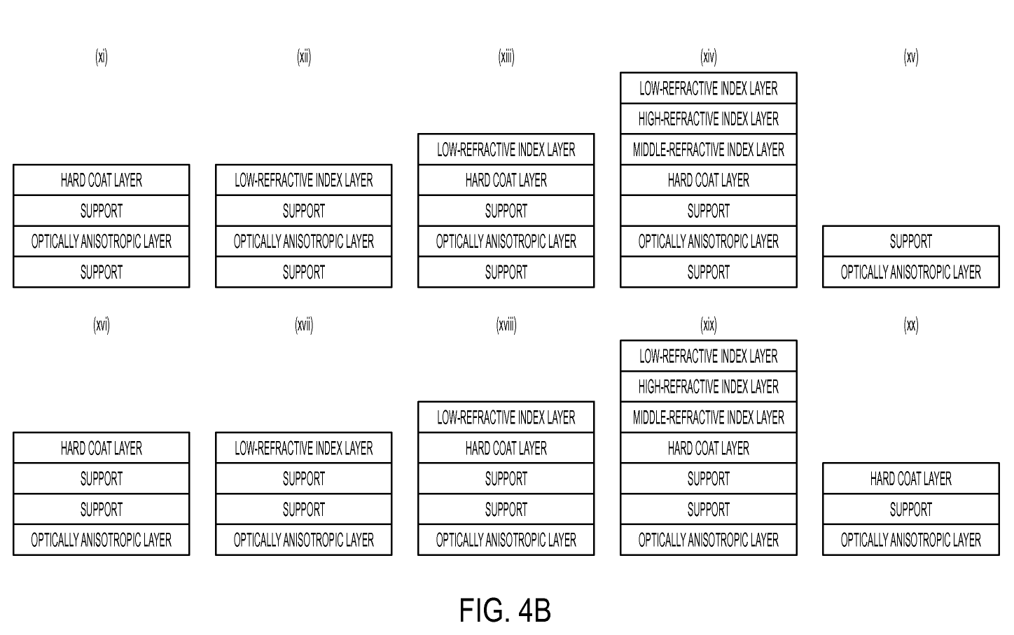

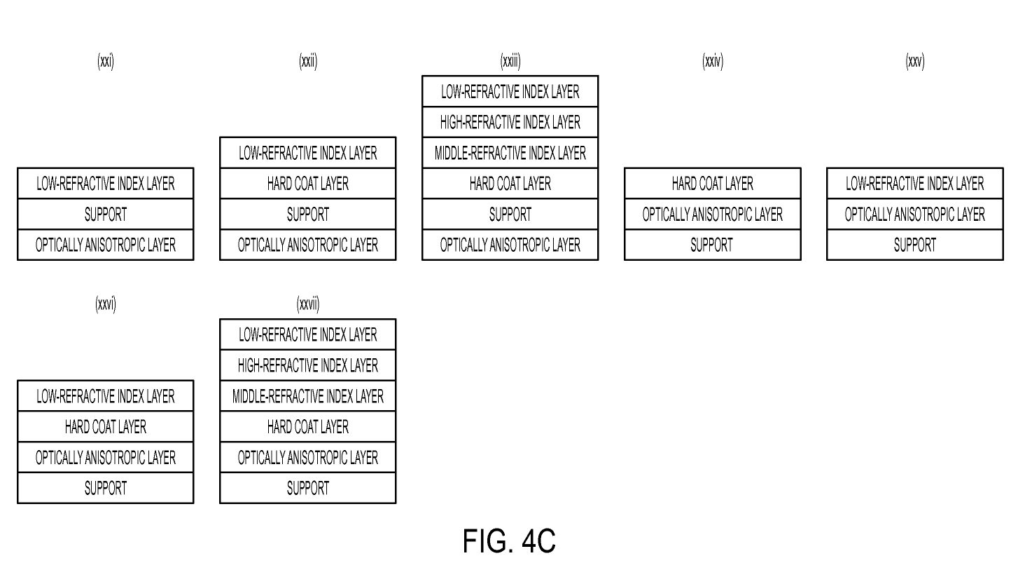

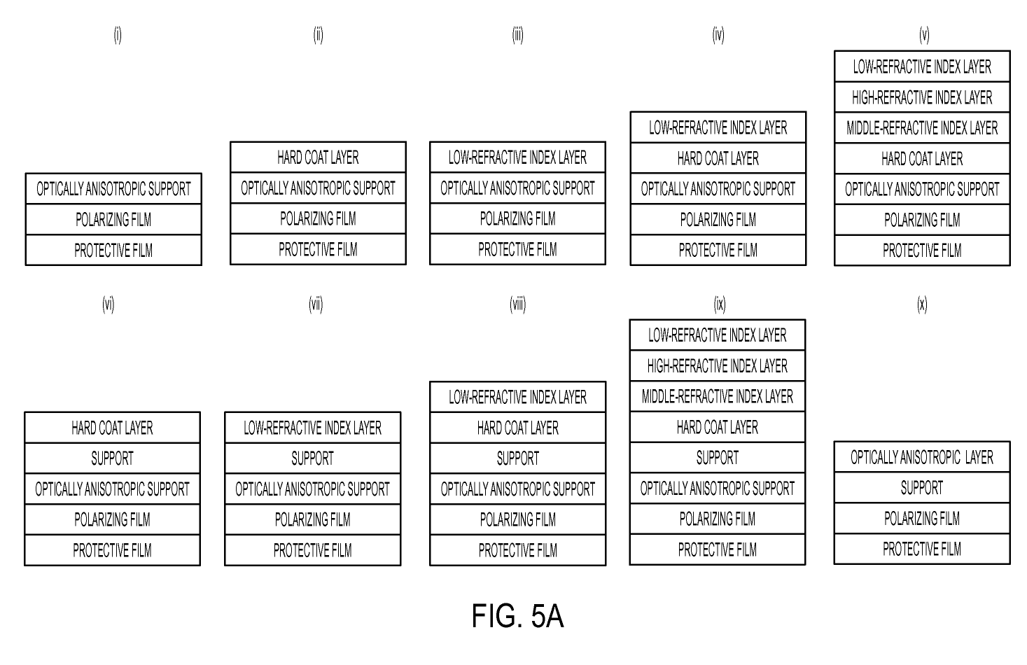

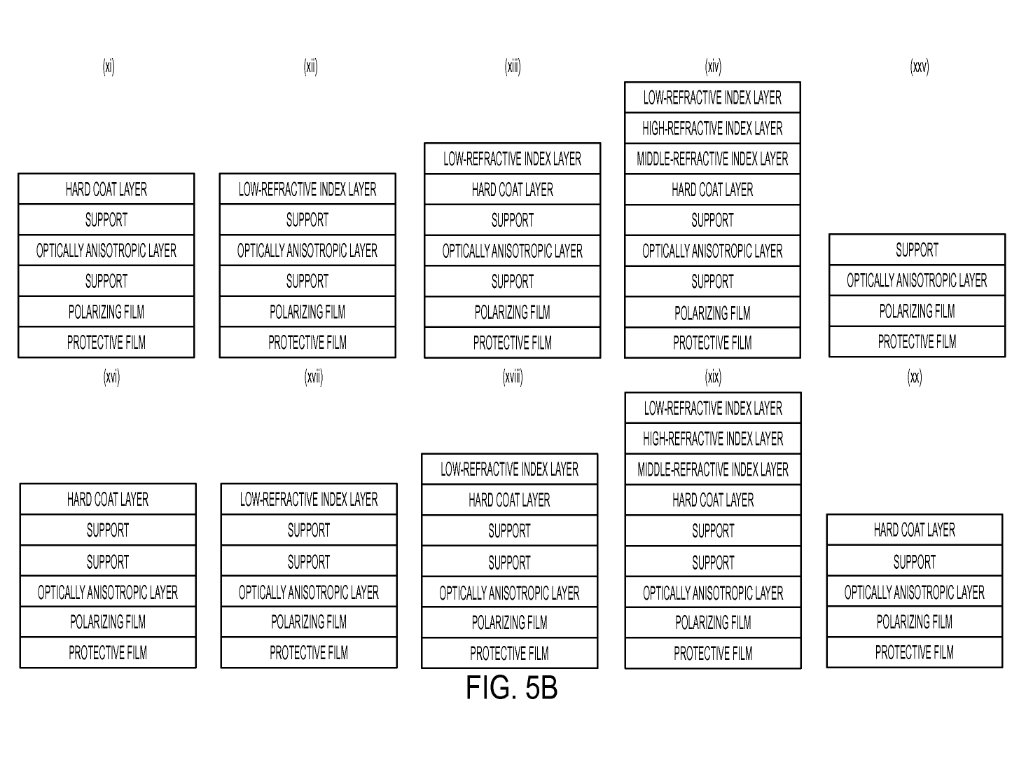

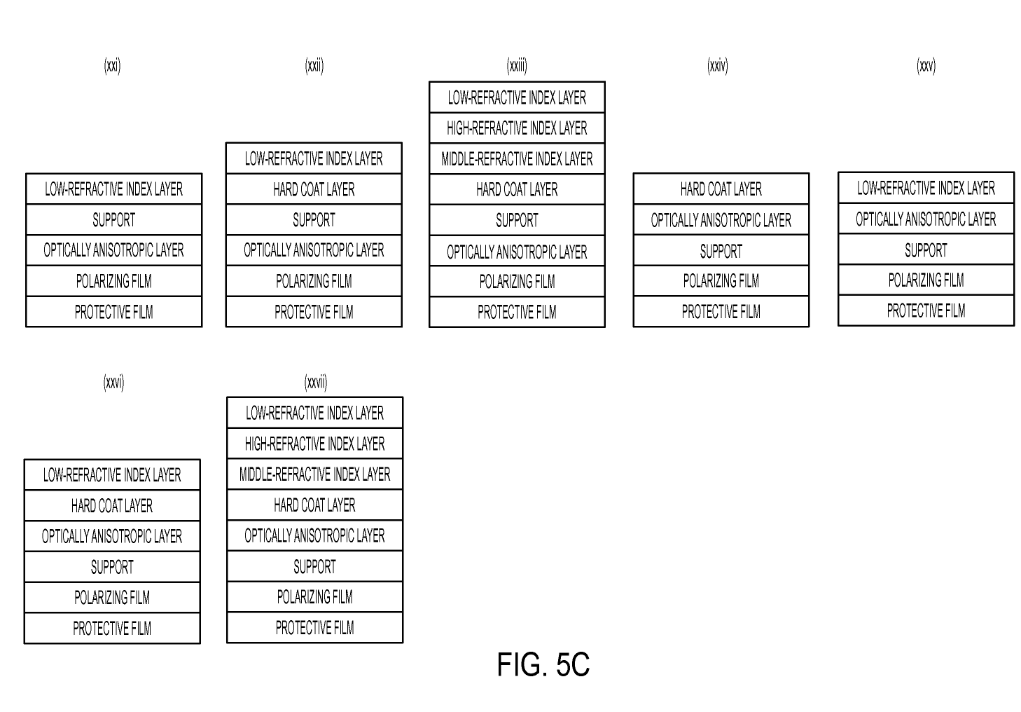

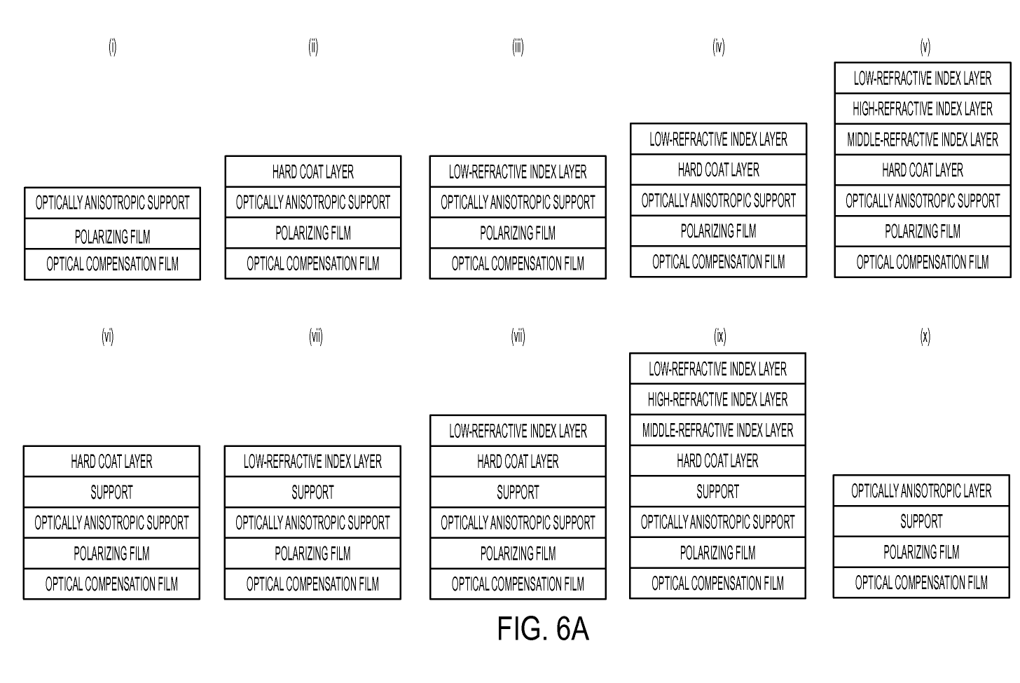

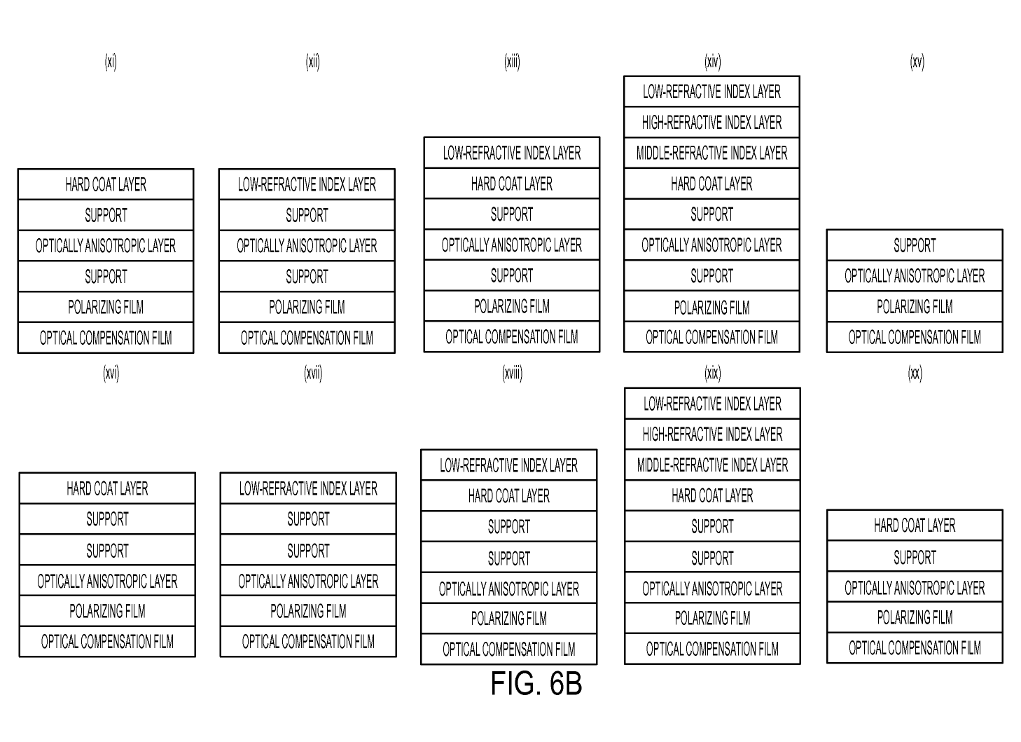

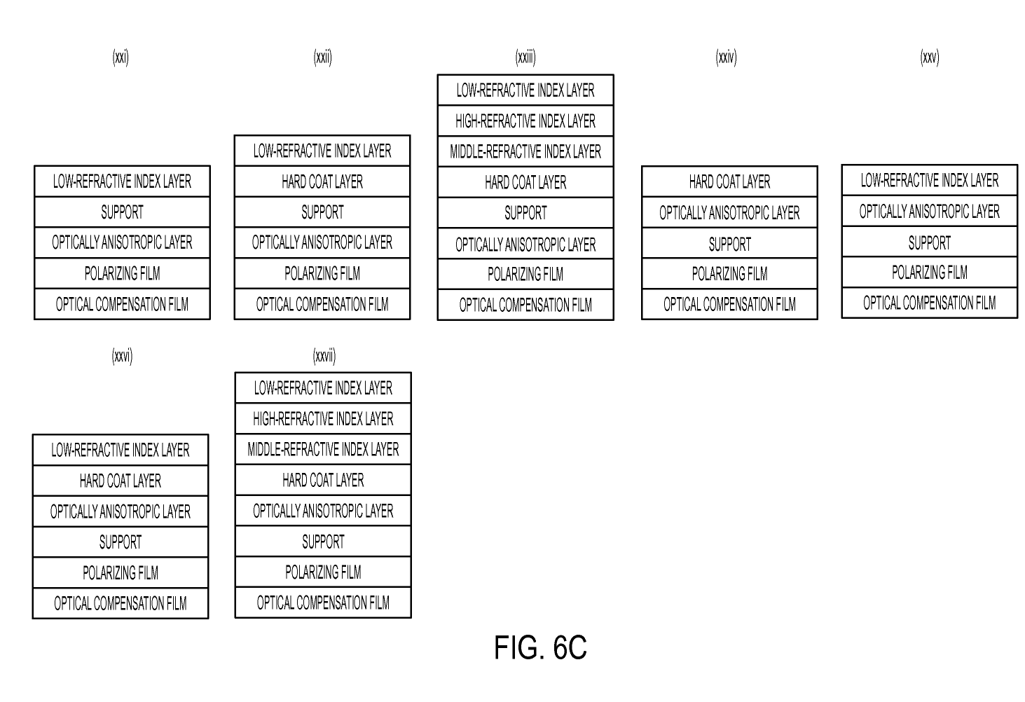

Examples of the construction of the protective member or the λ/4 plate are shown in FIGS. 4A, 4B, 4C, and the following description. In FIGS. 4A, 4B, 4C, and the following description, the terms “optically anisotropic support” means any retardation polymer film, and the term “support” means both of any retardation polymer film and any low-retardation polymer film of which optical characteristics are nearly equal to isotropy. The same is applied to FIGS. 5A-6C.

optically anisotropic support (FIG. 4A(i))

optically anisotropic support/hard coat layer (FIG. 4A(ii))

optically anisotropic support/low-refractive index layer (FIG. 4A(iii))

optically anisotropic support/hard coat layer/low-refractive index layer (FIG. 4A(iv))

optically anisotropic support/hard coat layer/middle-refractive index layer/high-refractive index layer/low-refractive index layer (FIG. 4A(v))

optically anisotropic support/support/hard coat layer (FIG. 4A(vi))

optically anisotropic support/support/low-refractive index layer (FIG. 4A(vii))

optically anisotropic support/support/hard coat layer/low-refractive index layer (FIG. 4A(viii))

optically anisotropic support/support/hard coat layer/middle-refractive index layer/high-refractive index layer/low-refractive index layer (FIG. 4A(ix))

support/optically anisotropic layer (FIG. 4A(x))

support/optically anisotropic layer/support/hard coat layer (FIG. 4B(xi))

support/optically anisotropic layer/support/low-refractive index layer (FIG. 4B(xii))

support/optically anisotropic layer/support/hard coat layer/low-refractive index layer (FIG. 4B(xiii))

support/optically anisotropic layer/support/hard coat layer/middle-refractive index layer/high-refractive index layer/low-refractive index layer (FIG. 4B(xiv))

optically anisotropic layer/support (FIG. 4B(xv))

optically anisotropic layer/support/support/hard coat layer (FIG. 4B(xvi))

optically anisotropic layer/support/support/low-refractive index layer (FIG. 4B(xvii))

optically anisotropic layer/support/support/hard coat layer/low-refractive index layer (FIG. 4B(xviii))

optically anisotropic layer/support/support/hard coat layer/middle-refractive index layer/high-refractive index layer/low-refractive index layer (FIG. 4B(xix))

optically anisotropic layer/support/hard coat layer (FIG. 4B(xx))

optically anisotropic layer/support/low-refractive index layer (FIG. 4C(xxi))

optically anisotropic layer/support/hard coat layer/low-refractive index layer (FIG. 4C(xxii))

optically anisotropic layer/support/hard coat layer/middle-refractive index layer/high-refractive index layer/low-refractive index layer (FIG. 4C(xxiii))

support/optically anisotropic layer/hard coat layer (FIG. 4C(xxiv))

support/optically anisotropic layer/low-refractive index layer (FIG. 4C(xxv))

support/optically anisotropic layer/hard coat layer/low-refractive index layer (FIG. 4C(xxvi))

support/optically anisotropic layer/hard coat layer/middle-refractive index layer/high-refractive index layer/low-refractive index layer (FIG. 4C(xxvii))

### (1) Polymer Film

The material of the retardation polymer film or the support for the optically anisotropic layer is not limited. Examples of the material which can be used include cellulose acylates (e.g., cellulose triacetate, cellulose diacetate, cellulose acetate butylate, and cellulose acetate propionate), polycarbonate series polymers, polyester series polymers such as polyethylene terephthalate and polyethylene naphthalate, acryl series polymers such as polymethylmethacrylate, styrene series polymers such as polystyrene and acryl nitrile/styrene copolymer (AS resin), polyolefins such as polyethylene and polypropylene, cycloolefin series polymers such as norbornene, polyolefin series polymers such as ethylene/propylene copolymers, vinyl chloride series polymers, amide series polymers such as nylon and aromatic polyamide, imide series polymers, sulfone series polymers, polyether sulfone series polymers, polyether ether ketone series polymers, polyphenylene sulfide series polymers, vinylidene chloride series polymers, vinyl alcohol series polymers, vinyl butyral series polymers, arylate series polymers, polyoxymethylene series polymers, epoxy series polymers and any mixtures thereof. One or two or more polymers may be used as a major ingredient. Any commercially-available polymers may be used, and examples thereof include ARTON (manufactured by JSR Corporation) which is a cycloolefin series polymer, and ZEONEX (manufactured by ZEON Corporation) which is an amorphous polyolefin. Among those, triacetyl cellulose, polyethylene terephthalate and cycloolefin series polymer are preferable, and triacetyl cellulose is more preferable.

The method for preparing the retardation polymer film is not limited. A solution casting film-forming method or a melt film-forming method may be used. For achieving the preferred properties, a stretching treatment may be carried out after the film-forming. If an optically anisotropic layer is formed on the polymer film, the polymer film may be subjected to a surface treatment (e.g., glow discharge treatment, corona discharge treatment, ultraviolet (UV) treatment, flame treatment, saponification treatment).

The thickness of the retardation polymer film is not limited, and generally, the polymer film having a thickness of from 25 to 1000 micro meters may be used.

The polymer film to be used as a support of the optically anisotropic layer described later may be selected from any polymer films having low-Re, and Re thereof may be from 0 to 50 nm, from 0 to 30 nm or from 0 to 10 nm. Rth of the polymer film is not limited, and for example, Rth of the polymer film is from −300 to 300 nm, from −100 nm to 200 nm or from −60 to 60 nm. The optical characteristics are preferably selected depending on the properties of the optically anisotropic layer to be formed on the polymer film.

Re or Rth of the support may be adjusted by adding any additive capable of controlling retardation or by carrying out any stretching treatment.

### (2) Optically Anisotropic Layer Containing Liquid Crystal Compound

The protective member or the λ/4 plate may have one or more optically anisotropic layers formed of a composition containing a liquid crystal compound. The kind of the liquid crystal compound is not limited. The optically anisotropic layer may be prepared by aligning low-molecular liquid crystal compound in the nematic phase and then fixing the alignment thereof via a photo-cross linking or a thermal cross-linking, or may be prepared by aligning high-molecular weight liquid crystal compound in the nematic phase and then fixing the alignment thereof under cooling. According to the invention, even if the optically anisotropic layer is formed by using any liquid crystal compound, the optically anisotropic layer is a layer which is formed by fixing the alignment of the liquid crystal compound, for example, via polymerization, and therefore, the liquid crystal compound in the layer doesn't have to exhibit any liquid crystallinity no longer. Any polymerizable liquid crystal compound may be used, and examples thereof include multifunctional polymerizable liquid crystal compounds and mono-functional polymerizable liquid crystal compounds. Examples of the liquid crystal compound include discotic liquid crystal compounds and rod-like liquid crystal compounds.

In the optically anisotropic layer, molecules of the liquid crystal compound are preferably fixed in any alignment state such as a vertical alignment, a horizontal alignment, a hybrid alignment and a tilt alignment. One example of the optically anisotropic layer is a layer in which discotic liquid crystal molecules are vertically aligned so that the discotic planes thereof are substantially vertical to the film surface (the surface of the optically anisotropic layer); and another example is a layer in which rod-like liquid crystal molecule are horizontally aligned so that the long axes thereof are substantially parallel to the film surface (the surface of the optically anisotropic layer). Regarding the discotic liquid crystal compound, the term “substantially vertical” means that the averaged value of the angle formed between the film surface (the surface of the optically anisotropic layer) and the discotic planes falls within the range of from 70 degrees to 90 degrees. The averaged angle is preferably from 80 to 90 degrees, or more preferably from 85 to 90 degrees. Regarding the rod-like liquid crystal compound, the term “substantially parallel” means that the averaged value of the angle formed between the film surface (the surface of the optically anisotropic layer) and the directors (long axes of the rod-like liquid crystal compound) falls within the range of from 0 degree to 20 degrees. The averaged angle is preferably from 0 to 10 degrees, or more preferably from 0 to 5 degrees.

When the optically anisotropic layer is prepared by aligning liquid crystal molecules in a hybrid alignment, the averaged tilt angle of the directors thereof is preferably from 5 to 85 degrees, more preferably from 10 to 80 degrees, or even more preferably from 15 to 75 degrees.

The optically anisotropic layer may be prepared by applying a coating liquid containing a liquid crystal compound such as a rod-like or discotic liquid crystal compound, and, if necessary, any additive such as a polymerization initiator described later and agent capable of controlling alignment to a surface of the support. The coating liquid is preferably applied to the surface of the alignment layer which may be formed on the support.

### [Rod-like Liquid Crystal Compound]

Examples of the rod-like liquid-crystalline compound which can be used for preparing the optically anisotropic layer include azomethine compounds, azoxy compounds, cyanobiphenyl compounds, cyanophenyl esters, benzoate esters, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds and alkenylcyclohexylbenzonitrile compounds. Not only the low-molecular-weight, liquid-crystalline compound as listed in the above, high-molecular-weight, liquid-crystalline compound may also be used. The rod-like liquid crystalline molecules are preferably fixed in an alignment state, and are more preferably fixed by a polymerization reaction. The liquid crystal compounds, having any moiety (moieties) capable of polymerizing or crosslinking under irradiation with an active light, electron ray or heat, are preferable. The number of such a moiety contained in each molecule is preferably from 1 to 6 and more preferably from 1 to 3. Examples of the polymerizable rod-like liquid crystalline compound applicable to the present invention include those described in Makromol. Chem., 190, p. 2255 (1989), Advanced Materials, 5, p. 107 (1993), U.S. Pat. No. 4,683,327, ditto U.S. Pat. No. 5,622,648, ditto U.S. Pat. No. 5,770,107, International Patent (WO) No. 95/22586, ditto No. 95/24455, ditto No. 97/00600, ditto No. 98/23580, ditto No. 98/52905, JP-A No. 1-272551, ditto No. 6-16616, ditto No. 7-110469, ditto No. 11-80081, and No. 2001-328973.

### [Discotic Liquid Crystal Compound]

The kind of the discotic liquid crystal compound to be used for preparing the optically anisotropic layer is not limited. Examples of the discotic liquid crystalline compound which can be used in the invention include benzene derivatives described in the Research Report of C. Destrade, et al., Mol. Cryst. vol. 71, p. 111 (1981), —truxene derivatives described in Research Report by C. Destrade, et al., Mol. Cryst. vol. 122, p. 141 (1985), Physics, lett, A, vol. 78, p. 82 (1990), cyclohexane derivatives described in Research Report of B. Kohne, et al., Angew. Chem. vol. 96, p. 70 (1984) and aza crown type or phenyl acetylene type macrocycles described in Research Report of M. Lehn, J. Chem. Commun., p. 1794 (1985), and Research Report of J. Zhang, J. Am. Chem. Soc., vol. 116, p. 2655 (1994). The polymerization of discotic liquid-crystal molecules is described in JP-A No. hei8-27284.

The discotic liquid crystal compound preferably has a polymerizable group so as to be fixed in any alignment state via polymerization. For example, as such a discotic liquid crystal compound, the compound having the structure in which polymerizable groups connect to the disk-like core thereof can be considered. However, when a polymerizable group is directly bonded to the disk-shaped core, it tends to be difficult to maintain alignment during the polymerization reaction. Accordingly, the discotic liquid-crystal molecule desirably comprises a linking group between the disk-shaped core and the polymerizable group. That is, the discotic liquid-crystal molecule is desirably the compound denoted by a formula below.

D(-L-P)ₙ

In the formula, D represents a discotic core, L represents a divalent linking group, p represents a polymerizable group and n is an integer from 4 to 12. Specific examples of the discotic core (D), the linking group (L) and the polymerizable group (P) are (D1) to (D15), (L1) to (L25) and (P1) to (P18), described in JPA No. 2001-4837, respectively, and the descriptions about those in JPA No. 2001-4837 are used in the present invention. The transition temperature of “the discotic nematic liquid crystal phase”/“the solid phase” is preferably from 30 to 300 degrees Celsius or more preferably from 30 to 170 degrees Celsius.

The compound represented by formula (I) may have low wavelength dispersion characteristics of Re, exhibit high Re, and achieve the vertical alignment excellent in the uniformity with a high averaged tilt angle even without using any specific alignment layer or any specific additive, and therefore, the compound is preferably used for preparing the optically anisotropic layer. Furthermore, the viscosity of the coating liquid containing the compound represented by formula (I) may tend to decrease relatively, which may result in improvement of the coating property; and therefore, the compound is preferable also in terms of the coating property.

### (1)-1 Discotic Liquid Crystal Compound Represented by Formula (I):

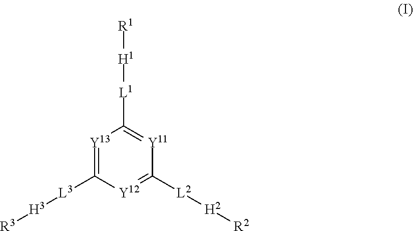

In the formula, Y¹¹, Y¹² and Y¹³ each independently represent a methine group or a nitrogen atom; L¹, L² and L³ each independently represent a single bond or a bivalent linking group; H¹, H² and H³ each independently represent the following formula (I-A) or (1-B): and R¹, R² and R³ each independently represent the following formula (I-R).

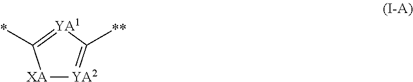

In formula (I-A), YA¹ and YA² each independently represent a methine group or a nitrogen atom; XA represents an oxygen atom, a sulfur atom, a methylene group or an imino group; * indicates the position at which the formula bonds to any of L¹ to L³ in formula (I); and ** indicates the position at which the formula bonds to any of R¹ to R³ in formula (I).

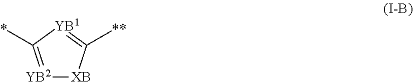

In formula (I-B), YB¹ and YB² each independently represent a methine group or a nitrogen atom; XB represents an oxygen atom, a sulfur atom, a methylene group or an imino group; * indicates the position at which the formula bonds to any of L¹ to L³ in formula (I); and ** indicates the position at which the formula bonds to any of R¹ to R³ in formula (I).

*-(-L²¹-Q²)ₙ₁-L²²-L²³-Q¹ (I-R)

In formula (I-R), * indicates the position at which the formula bonds to H¹, H² or H³ in formula (I); L²¹ represents a single bond or a bivalent linking group; Q² represents a bivalent (cyclic) group having at least one cyclic structure; n1 indicates an integer of from 0 to 4; L²² represents **—O—, **—O—CO—, **—CO—O—, **—O—CO—O—, —S—, **—NH—, **—SO₂—, **—CH₂—, **—CH═CH— or **—C≡C—; L²³ represents a bivalent linking group selected from —O—, —S—, —C(═O)—, —SO₂—, —NH—, —CH₂—, —CH═CH— and —C≡C—, and a group formed by linking two or more of these; and Q¹ represents a polymerizable group or a hydrogen atom.

Regarding the three-substituted benzene base discotic liquid crystal compound represented by formula (I), the preferable scopes of the symbols in the formula and the specific examples of the compound are described in JP-A-2010-244038, [0013]-[0077]. However, the discotic liquid crystal compound which can be used in the invention is not limited to the three-substituted benzene base discotic liquid crystal compound represented by formula (I).

Examples of the discotic liquid crystal compound include also, but are not limited to, the triphenylene compounds described in JP-A-2007-108732, [0062]-[0067].

The composition to be used for preparing the optically anisotropic layer may contain at least one pyridinium compound represented by formula (II) (more preferably formula (II′)) and at least one compound having a triazine-ring group represented by formula (III) along with the three-substituted benzene or the triphenylene compound. An amount of the pyridinium compound to be added to the composition is preferably from 0.5 to 3 parts by mass with respect to 100 parts by mass of the discotic liquid crystal compound. An amount of the compound having a triazine-ring group is preferably from 0.2 to 0.4 parts by mass with respect to 100 parts by mass of the discotic liquid crystal compound.

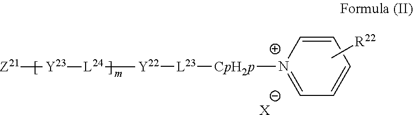

In the formula, L²³ and L²⁴ represent a divalent linking group respectively; R²² represents a hydrogen atom, non-substituted amino, or C₁₋₂₀ substituted amino; X represents an anion; Y²² and Y²³ represent a divalent linking group having a 5-membered or 6-membered ring as a part structure respectively; Z²¹ represents a monovalent group selected from the group consisting of a halogen-substituted phenyl, nitro-substituted phenyl, cyano-substituted phenyl, C₁₋₁₀ alkyl-substituted phenyl, C₂₋₁₀ alkoxy-substituted phenyl, C₁₋₁₂ alkyl, C₂₋₂₀ alkynyl, C₁₋₁₂ alkoxy, C₂₋₁₃ alkoxycarbonyl, C₇₋₂₆ aryloxycarbonyl and C₇₋₂₆ arylcarbonyloxy; p is an integer of from 1 to 10; and m is 1 or 2.

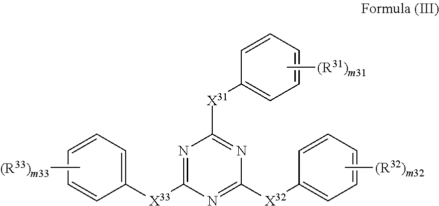

In the formula, R³¹, R³² and R³³ respectively represent an alkyl or alkoxy having a CF₃ group at the end thereof, provided that one or two or more carbon atoms, which are not adjacent to each other, in the alkyl (including the alkyl in the alkoxy) may be replaced with an oxygen or sulfur atom; X³¹, X³² and X³³ respectively represent a group formed by combining at least two bivalent groups selected from the group consisting of an alkylene, —CO—, —NH—, —O—, —S— and —SO₂—; and m31, m32 and m33 are respectively from 1 to 5. In formula (III), preferably, R³¹, R³² and R³³ each represent a group denoted by the following formula.

—O(CₙH₂ₙ)ₙ₁O(CₘH₂ₘ)ₘ₁—CₖF₂ₖ₊₁

In the formula, n and m are respectively from 1 to 3; n1 and m1 are respectively from 1 to 3; and k is from 1 to 10.

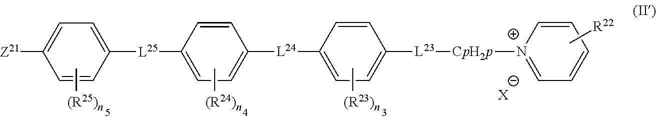

In formula (II′), each of the symbols has a same definition as that of each of the same symbols in formula (II); L²⁵ has a same definition as that of L²⁴; R²³, R²⁴ and R²⁵ respectively represent a C₁₋₁₂ alkyl; n3 is from 0 to 4; n4 is from 1 to 4; and n5 is from 0 to 4.

### [Other Additives]

The liquid crystal composition to be used for preparing the optically anisotropic layer may contain one or more other additives. Examples of the additive which can be used include an agent capable of controlling alignment at the air-interface, an agent capable of reducing defects (hajiki), a polymerization initiator and a polymerizable monomer.

### Agent Capable of Controlling Alignment at the Air-Interface:

The composition may be aligned with the air-interface tilt angle at the air-interface. The tilt angle may be varied depending on the types of the liquid crystal compounds or the additives to be used in the composition, and thus, it may be necessary to be adjusted to the appropriate range depending on the purpose.

The tilt angle may be controlled by application of an external force such as an electric and magnetic fields or addition of any additive(s). Adding any additive(s) is preferable. Examples of such an additive include compounds having at least one, preferably two or more, substituted or non-substituted C₆₋₄₀ aliphatic group(s) in a molecule and compounds having at least one, preferably two or more, substituted or non-substituted C₆₋₄₀ aliphatic oligosiloxanoxy group(s) in a molecule. For example, the hydrophobic compounds having an effect of excluding-volume disclosed in JPA No. 2002-20363 can be used as an agent capable of controlling alignment at the air-interface.

And the polymers having a fluoro-aliphatic group described in JP-A-2009-193046 may have the same function, and may be added to the composition as the agent capable of controlling alignment at the air-interface.

An amount of the agent capable of controlling alignment at the air-interface to be added to the composition is preferably from 0.001 to 20% by mass, more preferably from 0.01 to 10% by mass, and much more preferably from 0.1 to 5% by mass with respect to the total mass of the composition (if the composition is a coating liquid or the like, the total mass is the solid total mass, and hereinafter, the term has the same meaning).

### Agent Capable of Reducing Defects (Hajiki):

Usually, any polymer may be added to the composition for preventing any defects occurring in a coating step. The polymer to be used is not limited unless adding the polymer to the composition would change the tilt angle or inhibit the alignment of the composition remarkably.

Examples of the polymer include those described in JPA No. 8-95030; and among these, cellulose acylates are preferable. Examples of the cellulose acylate which can be used in the invention include cellulose acetate, cellulose acetate propionate, hydroxy propyl cellulose and cellulose acetate butyrate.

In terms of avoiding inhibition of the alignment, the amount of the polymer to be added to the composition is preferably from 0.1 to 10% by mass, more preferably from 0.1 to 8% by mass, and much more preferably from 0.1 to 5% by mass with respect to the total mass of the composition.

### Polymerization Initiator:

The composition preferably comprises a polymerization initiator. The composition containing a polymerization initiator may be heated by the temperature at which the composition exhibits a liquid crystal phase, be polymerized and then be cooled, thereby to fix the alignment. Examples of the polymerization reaction include thermal polymerization reactions using a thermal polymerization initiator, photo-polymerization reactions using a photo-polymerization initiator and polymerizations with irradiation of electron beam. Photo-polymerization reactions and polymerizations with irradiation of electron beam are preferred in terms of avoiding deformation or degradation of the support or the like.

Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication No. S60-105667 and U.S. Pat. No. 4,239,850), and oxadiazole compounds (those described in U.S. Pat. No. 4,212,970).

An amount of the photo-polymerization initiator to be used is preferably from 0.01 to 20% by mass, or more preferable from 0.5 to 5% by mass, with respect to the composition.

### Polymerizable Monomer:

The composition may contain polymerizable monomer(s). The polymerizable monomer which can be used in the invention is not limited so far as the monomer is compatible with the liquid crystal compound and doesn't inhibit the alignment of the composition remarkably. The compound having any polymerizable ethylenic unsaturated group(s) such as vinyl, vinyloxy, acryloyl and methacryloyl is preferably used.

An amount of the polymerizable monomer to be added to the composition is preferably 0.5 to 50% by mass, and more preferably 1 to 30% by mass with respect to the total mass of the composition. Using any monomer having two or more reactive groups in a molecule is preferable in terms of improvement in the adhesion to the alignment layer.

The composition may be prepared as a coating liquid. The solvent which is used for preparing the coating liquid is desirably selected from organic solvents. Examples of the organic solvent include amides such as N,N-dimethylformamide, sulfoxides such as dimethylsulfoxide, heterocyclic compounds such as pyridine, hydrocarbons such as benzene or hexane, alkyl halides such as chloroform or dichloromethane, esters such as methyl acetate or butyl acetate, ketones such as acetone or methylethyl ketone and ethers such as tetrahydrofuran or 1,2-dimethoxyethane. Among these, esters and ketones are preferable; and ketones are more preferable. Plural types of organic solvents may be used in combination.

The optically anisotropic layer may be prepared by fixing the alignment of the composition. One example of the method for preparing the optically anisotropic layer is described below. However, the method is not limited to the method described below.

At first, the composition containing at least one polymerizable liquid crystal compound is applied to a surface of a support or an alignment layer formed on the support. If necessary, the composition is heated, and then aligned in a desired alignment state. Next, polymerization is carried out to fix the alignment state. In this way, the optically anisotropic layer can be produced. Examples of the additive which can be added to the composition include the agent capable of controlling alignment at the air-interface, the agent capable of reducing defects (hajiki), the polymerization initiator and the polymerizable monomer described above.

The coating liquid may be applied to a surface according to various techniques (e.g., wire bar coating, extrusion coating, direct gravure coating, reverse gravure coating and die coating).

For achieving a uniform alignment, an alignment layer is preferably used. The alignment layer prepared by rubbing a surface of a polymer layer (e.g., polyvinyl alcohol layer or polyimide layer) is preferable. Preferable examples of the alignment layer which can be used in the invention include the alignment layer formed of the acrylic acid-copolymer or the methacrylic acid-copolymer described in JP-A-2006-276203, [0130]-[0175]. By using the alignment layer, it is possible to prevent fluctuation of the liquid crystal compound and to achieve the high contrast.

Next, for fixing the alignment state, preferably, polymerization is carried out. Preferably, the composition containing a polymerization initiator is used and polymerization of the composition is carried out under irradiation with light. UV light is preferably used. The irradiation energy is preferably 10 mJ/cm² to 50 J/cm², more preferably 50 mJ/cm² to 800 mJ/cm². Irradiation may be carried out under heating to accelerate the photo-polymerization reaction. The concentration of oxygen in the atmosphere may influence the polymerization degree. Therefore, when the desired polymerization degree is not achieved during the polymerization under air, preferably, the concentration of oxygen is lowered by replacing air with nitrogen gas. The concentration of oxygen is preferably equal to or less than 10%, more preferably equal to or less than 7% and even more preferably equal to or less than 3%.

In the present invention, the meaning of “a fixed alignment state” is a typical and most preferable state, that is, a state maintaining the alignment; however, it is not limited to the typical state. More specifically, the meaning of “a fixed alignment state” indicates the state which has no fluidity at a temperature within the range from 0 to 50 degrees Celsius, or, under severer condition, from −30 to 70 degrees Celsius, is not changed depending on any external field or any external force and is stably kept. It is to be noted that after the optically anisotropic layer is formed by fixing the alignment state, the composition has any liquid crystallinity no longer. For example, the liquid crystal compound may lose any liquid crystallinity after it is polymerized by polymerization or crosslinking-reaction under irradiation with heat or light.

The thickness of the optically anisotropic layer is not limited, and generally, from about 0.1 to abut 10 micro meters, or more preferably from about 0.5 to about 5 micro meters.

For preparing the optically anisotropic layer, any alignment layer may be used, and examples thereof include any alignment layers prepared by rubbing the surface of the layer containing polyvinyl alcohol or modified polyvinyl alcohol as a main ingredient.

The retardation film or the optically anisotropic layer is preferably prepared as a long film continuously. Furthermore, the slow axis thereof is preferably not parallel or orthogonal to the long direction since bonding to a polarizing film according to a roll-to-roll manner can be carried out by allowing the slow axis to be along the direction of 45° or 135° relative to the absorption axis of the polarizing film. Namely, the angle formed between the slow axis of the retardation film or the optically anisotropic layer and the long axis is preferably from 5 to 85°.

The direction of the slow axis of the optically anisotropic layer may be adjusted by the angle of the rubbing treatment. The slow axis of the stretched film may be adjusted by the direction of the stretching treatment.

### (3) Surface Layer

Depending on the purpose, any surface layer having a single-layer- or multilayered-construction may be formed on the surface of the protective member or the λ/4 plate. As the preferable embodiment, exemplified are the embodiment in which a hard coat layer is disposed on the optically anisotropic layer, the embodiment in which an antireflective layer is disposed on the optically anisotropic layer, and the embodiment in which an antireflective layer is disposed on a hard coat layer disposed on the optically anisotropic layer.

### [Antireflective Layer]

An antireflective layer may be formed of one or more layers and be designed with any factor such as a refractive index, a film thickness, a number of layers and an order of layers so as to reduce the reflectivity by optical interference.

The simplest construction thereof may be the construction in which only a low-refractive index layer is formed on the outermost surface of a film. In order to further reduce the reflectivity, the antireflective layer preferably has a construction in which a high refractive index layer having a higher refractive index and a low refractive index layer having a lower refractive index are provided in combination. Examples of the construction include a two-layer construction having a high refractive index layer/low refractive index layer provided from the side of the transparent substrate, a construction having three layers having different refractive indices to form a laminate of a middle refractive index layer (layer having a refractive index which is than that of the lower layer and lower than that of the upper layer)/a high refractive index layer/a low refractive index layer in this order, and a construction having lamination of a larger number of antireflective layers is also proposed. Among them, a construction having a middle refractive index layer/a high refractive index layer/a low refractive index layer in this order on a transparent substrate having a hard coat layer is preferred from the standpoint, for example, of durability, optical characteristics, cost or productivity, and examples thereof include constructions described, for example, in JP-A-8-122504, JP-A-8-110401, JP-A-10-300902, JP-A-2002-243906 and JP-A-2000-111706. The anti-reflective film, having the three-layered construction, excellent in the robust property against the variation of the thickness is described in JP-A-2008-262187. By disposing the three-layered antireflective film on the surface of the display device, it is possible to reduce the averaged value of reflectivity to 0.5% or less, to reduce the reflection remarkably, and to obtain the images excellent in 3D appearance. Further, a different function may be imparted on each layer, and examples of such a layer include a low refractive index layer having an antifouling property, a high refractive index layer having antistatic property (for example, JP-A-10-206603 or JP-A-2002-243906).

Examples of the construction of the hard coat layer or the antireflective layer are described below. In the following examples, the term “-*/” means the substrate on which the surface layer is disposed. More specifically, examples of “-*/” include the above-described optically anisotropic support, optically anisotropic layer and support.
-*/hard coat layer,
-*/low-refractive index layer,
-*/anti-glare layer/low-refractive index layer
-*/hard coat layer/low-refractive index layer,
-*/hard coat layer/anti-glare layer/low-refractive index layer
-*/hard coat layer/high-refractive index layer/low-refractive index layer
-*/hard coat layer/middle-refractive index layer/high-refractive index layer/low-refractive index layer
-*/hard coat layer/anti-glare layer/high-refractive index layer/low-refractive index layer
-*/hard coat layer/anti-glare layer/middle-refractive index layer/high-refractive index layer/low-refractive index layer
-*/anti-glare layer/high-refractive index layer/low-refractive index layer
-*/anti-glare layer/middle-refractive index layer/high-refractive index layer/low-refractive index layer

Among the above described constructions, the constructions having a hard coat layer and an antiglare layer disposed on the optically anisotropic layer directly are preferable. An optical film having the optically anisotropic layer and an optical film having a hard coat layer disposed on a support film may be prepared respectively, and then bonded to each other.

### [Hard Coat Layer]

According to the invention, the protective member may have a hard coat layer in the antireflective film (surface film) thereof. Although the protective member may not have any hard coat layer, the protective member preferably has a hard coat layer since it may become strong in terms of abrasion-resistance according to the pencil-scratch test or the like.

Preferably, the antireflective film comprises a hard coat layer and a low-refractive index layer which is disposed on the hard coat layer, or more preferably, further comprises a middle-refractive index layer and a high-refractive index layer which are disposed between the hard coat layer and the low-refractive index layer. The hard coat layer may be constituted by two or more layers.

The refractive index of the hard coat layer is preferably from 1.48 to 2.00, or more preferably from 1.48 to 1.70 in terms of the optical design for obtaining the antireflective film.

In terms of obtaining sufficient durability and impact resistance, the thickness of the hard coat layer is generally from about 0.5 to about 50 micro meters, preferably from about 1 to about 20 micro meters, or more preferably from about 5 to about 20 micro meters.

The strength of the hard coat layer is preferably H or more, more preferably 2H or more, even more preferably 3H or more, in a pencil hardness test. Further, regarding the amount of abrasion of a test piece after Taber abrasion test according to JIS K5400, a hard coat layer having a smaller abrasion amount is more preferred.

The hard coat layer is formed preferably by cross-linking reaction of polymerization reaction of a compound curable with ionization radiation. For example, it may be formed by coating on a transparent support a coating composition containing a multi-functional monomer or multi-functional oligomer which can be cured by ionization radiation, and performing cross-linking reaction or polymerization reaction of the multi-functional monomer or multi-functional oligomer. As the functional group of the ionization radiation-curable, multi-functional monomer or multi-functional oligomer, those functional groups which can be polymerized by light, electron beams or radiation are preferred, with photo-polymerizable functional groups being particularly preferred. As the photo-polymerizable functional groups, there are illustrated polymerizable functional groups such as a (meth)acryloyl group, a vinyl group, a styryl group and an allyl group. Of these, a (meth)acryloyl group and —C(O)OCH═CH₂ are preferred.

Specific examples of the compound curable with ionization radiation include (meth)acrylic acid diesters of alkylene glycol, (meth)acrylic acid diesters of polyoxyalkylene glycol, (meth)acrylic acid diesters of polyhydric alcohol, (meth)acrylic acid diesters of ethylene oxide or propylene oxide adduct, epoxy (meth)acrylates, urethane (meth)acrylates and polyester (meth)acrylates.

As the (meth)acryloyl group-containing polyfunctional acrylate-based compounds, a commercially available compound may also be used, and examples thereof include “NK Ester A-TMMT” produced by SHIN-NAKAMURA CHEMICAL CO, LTD. and “KAYARAD DPHA” produced by Nippon Kayaku Co., Ltd. The multi-functional monomer is described in JP-A-2009-98658, [0114]-[0122], and the same applies to the present invention.

As the compound curable with ionization radiation, compounds having a substituent(s) capable of forming a hydrogen bond are preferable in terms of adhesion to the support or low curl-property. The substituent capable of forming a hydrogen bond includes any substituents in which an atom, having large electronegativity, such as a nitrogen atom, an oxygen atom, a sulfur atom and a halogen atom is attached to a hydrogen atom via a covalent binding; and examples thereof include OH—, SH—, —NH—, CHO— and CHN—. Urethane (meth)acrylates and (meth)acrylates having a hydroxy are preferable. A commercially available compound may also be used, and examples thereof include “NK Oligomer U4HA” and “NK Ester A-TMMT-3” produced by SHIN-NAKAMURA CHEMICAL CO, LTD. and “KAYARAD PET-30” produced by Nippon Kayaku Co., Ltd.

The hard coat layer may contain matting particles having a mean diameter of from 1.0 to 10.0 micro meters, or more preferably from 1.5 to 7.0 micro meters, such as particles of any inorganic compound or any polymer, for the purpose of imparting internal scattering.

The binder of the hard coat layer may contain both of inorganic particles and a monomer having any refractive index, for the purpose of controlling the refractive index thereof. The inorganic particles may have not only a function capable of controlling the refractive index but also a function capable of preventing the curing-shrinkage via the cross-linking reaction. According to the invention, the term “binder” means a polymer, in which inorganic particles are dispersed, formed by polymerization of the multi-function monomer and/or the high-refractive index monomer, in which inorganic particles are dispersed.

### [Antiglare Layer]

An antiglare layer may be formed so that antiglare property due to surface scattering and preferably hard coat property for enhancing the hardness and scratch resistance of the film can be imparted to the film.

The antiglare layer is described in paragraphs [0178] to [0189] of JP-A-2009-98658 and the same applies to the present invention.

### [High-Refractive Index Layer and Middle-Refractive Index Layer]

The refractive index of the high-refractive index layer is preferably from 1.70 to 1.74, or more preferably from 1.71 to 1.73. The refractive index of the middle-refractive index layer is adjusted to have a value between the refractive index of the low-refractive index layer and the refractive index of the high-refractive index layer. The refractive index of the middle refractive index layer is preferably from 1.60 to 1.64, or more preferably from 1.61 to 1.63.

As for the method of forming the high-refractive index layer and the middle-refractive index layer, a transparent inorganic oxide thin film formed by a chemical vapor deposition (CVD) method or a physical vapor deposition (PVD) method, particularly, a vacuum deposition method or a sputtering method, which are a kind of physical vapor deposition method, may be used, but a method by all-wet coating is preferred.

The middle-refractive index layer and the high-refractive layer may be prepared according to a same method using same materials as long as the refractive indexes are different from each other. Therefore, only the method for preparing the high-refractive index layer is described in detail below.

The high-refractive index layer may be prepared as follows. A coating composition containing inorganic particles, a curable compound having three or more polymerizable groups (occasionally referred to as “binder”), a solvent and a polymerization initiator is prepared, applied to a surface, dried so that the solvent is removed, and then cured under irradiation with heat and/or ionization radiation. According to the method employing the curable compound and polymerization initiator, it is possible to prepare the high-refractive index layer or the middle-refractive index layer, which is excellent in scratch resistance and adhesion, by carrying out the polymerization under irradiation with heat and/or ionization radiation after coating.

### [Low-Refractive Index Layer]

The refractive index of the low-refractive index layer is preferably from 1.30 to 1.47. According to the embodiment wherein the surface film is constructed by a multilayer thin-film interference-type antireflective film (middle-refractive index layer/high-refractive index layer/low-refractive index layer), the refractive index of the low-refractive index layer is preferably is preferably from 1.33 to 1.38, or more preferably from 1.35 to 1.37. The refractive index in this range is preferred, because the reflectance can be reduced and the film strength can be maintained. As for the method of forming the low refractive index layer, a transparent inorganic oxide thin film formed by a chemical vapor deposition (CVD) method or a physical vapor deposition (PVD) method, particularly, a vacuum deposition method or a sputtering method, which are a kind of physical vapor deposition method, may be used, but a method by all-wet coating using a composition for the low refractive index layer is preferably employed.

The low refractive index layer may be formed of a composition containing a curable polymer having fluorine, a curable monomer having fluorine, a curable monomer having no fluorine and low-refractive index particles. As these materials, those described in JP-A-2010-152311, [0018]-[0168] may be used.

Haze of the low-refractive index layer is preferably equal to less than 3%, more preferably equal to or less than 2%, or even more preferably equal to or less than 1%.

The strength of the antireflective film prepared by finally forming the low-refractive index layer is preferably H or more, more preferably 2H or more, or even more preferably 3H or more, in a pencil hardness test with a 500 g load.

The contact angle against water of the surface is 95° or more, in terms of improving the antifouling property of the antireflective film. More preferably, the contact angle is 102° or more. The contact angle of equal to or more than 105° may improve the antifouling property against finger-patterns remarkably, which is especially preferable. According to the preferable embodiment, the water contact angle is equal to or more than 102° and the surface free energy is equal to or less than 25 dyne/cm, more preferably equal to or less than 23 dyne/cm, or even more preferably equal to or less than 20 dyne/cm. According to the most preferable embodiment, the water contact angle is equal to or more than 105° and the surface free energy is equal to or less than 20 dyne/cm.

### (4) Ultraviolet Absorber

According to the invention, the protective member and the λ/4 plate preferably contain any ultraviolet absorber(s) respectively. According to the embodiment wherein the protective member or the λ/4 preferably is formed of plural layers, at least one of the layers preferably contains any ultraviolet absorber(s). For example, according to the embodiment comprising a transparent support, an optically anisotropic layer, an antireflective layer and an adhesion layer optionally disposed between them, the ultraviolet absorber may be added to any one of them. Or the ultraviolet absorber may be added to the hard coat layer and/or the antireflective layer in the surface film. As the ultraviolet absorber, any known compounds exhibiting the ultraviolet absorptivity may be used. Among such ultraviolet absorbers, for obtaining the high ultraviolet absorptivity and the ultraviolet-protect ability which is used in an electronic image display device, benzotriazole series and hydroxyphenyl triazine series ultraviolet-absorbers are preferable. For widening the absorption width for the ultraviolet ray, two or more types of ultraviolet absorbers may be used.

Examples of the benzotriazole-type UV absorber include 2-[2′-hydroxy-5′-(methacryloyloxymethyl)phenyl]-2H-benzotriazole, 2-[2′-hydroxy-5′-(methacryloyloxyethyl)phenyl]-2H-benzotriazole, 2-[2′-hydroxy-5′-(methacryloyloxypropyl)phenyl]-2H-benzotriazole, 2-[2′-hydroxy-5′-(methacryloyloxyhexyl)phenyl]-2H-benzotriazole, 2-[2′-hydroxy-3′-tert-butyl-5′-(methacryloyloxyethyl)phenyl]-2H-benzotriazole, 2-[2′-hydroxy-5′-tert-butyl-3′-(methacryloyloxyethyl)phenyl]-2H-benzotriazole, 2-[2′-hydroxy-5′-(methacryloyloxyethyl)phenyl]-5-chloro-2H-benzotriazole, 2-[2′-hydroxy-5′-(methacryloyloxyethyl)phenyl]-5-methoxy-2H-benzotriazole, 2-[2′-hydroxy-5′-(methacryloyloxyethyl)phenyl]-5-cyano-2H-benzotriazole, 2-[2′-hydroxy-5′-(methacryloyloxyethyl)phenyl]-5-tert-butyl-2H-benzotriazole, 2-[2′-hydroxy-5′-(methacryloyloxyethyl)phenyl]-5-nitro-2H-benzotriazole, 2-(2-hydroxy-5-tert-butylphenyl)-2H-benzotriazole, benzene propanoic acid-3-(2H-benzotriazole-2-yl)-5-(1,1-dimethylethyl)-4-hydroxy-, C₇₋₉-branched liner alkyl ester, 2-(2H-benzotriazole-2-yl)-4,6-bis(1-methyl-1-phenylethyl)phenol, and 2-(2H-benzotriazole-2-yl)-6-(1-methyl-1-phenylethyl)-4-(1,1,3,3-tetra methyl butyl)phenol.

Examples of the hydroxy phenyl triazine-type UV absorber include 2-[4-[(2-hydroxy-3-dodecyloxypropyl)oxy]-2-hydroxyphenyl-4,6-bis(2,4-dimethyl phenyl)-1,3,5-triazine, 2-[4-(2-hydroxy-3-tridecyloxypropyl)oxy]-2-hydroxyphenyl]-4,6-bis (2,4-dimethylphenyl)-1,3,5-triazine, 2-[4-[(2-hydroxy-3-(2′-ethyphexyl)oxy]-2-hydroxyphenyl]-4,6-bis (2,4-dimethylphenyl)-1,3,5-triazine, 2,4-bis(2-hydroxy-4-butyloxy phenyl)-6-(2,4-bis-butyloxyphenyl)-1,3,5-triazine, 2-(2-hydroxy-4-[1-octyloxycarbonylethoxy]phenyl)-4,6-bis(4-phenylphenyl)-1,3,5-triazine, 2,2′,4,4′-tetrahydroxy benzophenone, 2,2′-dihydroxy-4,4′-dimethoxybenzophenone, 2,2′-dihydroxy-4-methoxybenzophenone, 2,4-dihydroxy benzophenone, 2-hydroxy-4-acetoxyethoxy benzophenone, 2-hydroxy-4-methoxy benzophenone, 2,2′-dihydroxy-4-methoxy benzophenone, 2,2′-dihydroxy-4,4′-dimethoxy benzophenone, 2-hydroxy-4-n-octoxy benzophenone, and 2,2′-dihydroxy-4,4′-dimethoxy-5,5′-disulfobenzophenone.disodium salt.

An amount of the ultraviolet absorber may be decided depending on the desired UV-ray transmission or the absorbance of the ultraviolet absorber, and is generally 20 parts by mass or less, or preferably from 1 to 20 parts by mass with respect to 100 parts by mass of the curable composition. If the amount thereof is more than 20 parts by mass, the curing property of the composition under irradiation with UV-ray may tend to decrease and the visible-light transmission of the layer may tend to decrease, which is not preferable. On the other hand, if the amount thereof is less than 1 part by mass, the ultraviolet absorptivity of the layer may not develop sufficiently.

### 2. Polarizing Film

The display device to be used in the alternate-frame sequencing 3D display system of the invention has at least one polarizing film (first polarizing film) disposed at the observer-side. According to the embodiment wherein the display device is a transmissive-type liquid crystal panel, another polarizing film is disposed at the backlight-side. And according to the embodiment wherein the alternate-frame sequencing shutter employs a shutter function due to a liquid crystal cell, the alternate-frame sequencing shutter may have a polarizing film or two polarizing films between which the liquid crystal cell is disposed.

The polarizing film to be sued in the alternate-frame sequencing display device of the invention is not limited, and may be selected from any normal polarizing films. Examples thereof include an iodine-base polarizing film, a dye-base polarizing film with a dichroic dye, and a polyene-base polarizing film, and any of these is usable in the invention. The iodine-base polarizing film and the dye-base polarizing film are produced generally by absorbing iodine or a dichroic dye to a polyvinyl alcohol film, and then stretching the film.

For preventing the variation of coloration in the head-inclination-state, the first polarizing film is disposed so that the absorption axis thereof is 45° or 135° relative to the horizontal direction of the visual surface. It is possible to prevent the variation of coloration in the head-inclination-state by disposing the polarizing film so that the absorption axis thereof is 45° or 135° relative to the horizontal direction of the visual surface and disposing the protective member so that the slow axis thereof is 0° or 90° relative to the horizontal direction of the visual surface

A polarizing film is generally used in the form of a polarizing plate having two protective films which are attached to both surfaces of the polarizing film. According to the invention, any polarizing plate having such a construction may be used. Examples of the polarizing plate having the protective member or the λ/4 plate include, but are not limited to, those shown in FIGS. 5A, 5B, and 5C and FIGS. 6A, 6B, and 6C. The optical compensation film in each of the examples shown in FIGS. 6A, 6B, and 6C may optically compensate the viewing angle characteristics of a liquid crystal cell.

### 3. Liquid Crystal Cell

The mode of the liquid crystal cell to be used in the alternate-frame sequencing display device of the invention is not limited. According to a TN-mode, OCB-mode or ECB mode, a polarizing film is generally disposed so that the absorption axis thereof is 45° or 135° relative to the horizontal direction of the visual surface; and therefore, the display device employing such a mode may be used in the invention without making any modification on the construction.

The construction of the alternate-frame sequencing shutter is not limited. One example thereof is the shutter employing a liquid crystal cell. The construction of the liquid crystal cell to be used is not limited. The liquid crystal cell may have a pair of substrates, a liquid crystal layer disposed between the substrates, and other element(s) which are necessary for constructing a liquid crystal cell employing any mode. Examples of the mode of the liquid crystal cell include TN (Twisted Nematic) mode, STN (Super Twisted Nematic) mode, ECB (Electrically Controlled Birefringence) mode, IPS (In-Plane Switching) mode, VA (Vertical Alignment) mode, MVA (Multidomain Vertical Alignment) mode, PVA (Patterned Vertical Alignment) mode, OCB (Optically Compensated Birefringence) mode, HAN (Hybrid Aligned Nematic) mode, ASM (Axially Symmetric Aligned Microcell) mode, Half-tone gray scale mode, Multi-domain partitioning mode, and any modes employing ferroelectric liquid crystal or antiferroelectric liquid crystal. The drive system of the liquid crystal cell is also not limited; and any of passive matrix system adopted to STN-LCD and so forth; active matrix system making use of active electrodes such as those for TFT (Thin Film Transistor), TFD (Thin Film Diode) and so forth; and plasma address system, may be adoptable. A field sequential system without any color filter may also be used.

A liquid crystal cell of OCB mode adopts a bent alignment in which the rod-shaped liquid crystal molecules are aligned in substantially opposite directions (in symmetric manner) in upper and lower portions of the liquid crystal cell. In a liquid crystal display apparatus employing a liquid crystal cell of such bent alignment mode as described in U.S. Pat. Nos. 4,583,825 and 5,410,422, the liquid crystal cell of the bent alignment mode has an optical self-compensating function, because of alignments symmetrical in the upper and lower portions of the liquid crystal cell. For this reason, such liquid crystal mode is called an OCB (optically compensatory bend) mode. An advantage of the OCB mode resides in the fast response speed.

In a liquid crystal cell of TN mode, rod-shaped liquid crystal molecules are aligned substantially horizontally and twisted with a twisting angle of from 60 to 120° while there is no applied voltage. A liquid crystal cell of TN mode is most frequently employed as a color TFT liquid crystal display apparatus, and is described in various literatures.

In an ECB mode liquid crystal cell, rod-like liquid crystalline molecules are aligned substantially horizontally when no voltage is applied, and the cell is most popularly utilized as a color TFT liquid crystal display device and is described in many literatures. For example, it is described in EL, PDP, LCD Display published by Toray Research Center (2001).

The liquid crystal cell to be used in the display device may be selected in terms of display quality; and the liquid crystal cell to be used in the alternate-frame sequencing shutter may be selected in terms of the response speed and the transmittance since it should respond to the left-eye and right eye images respectively. And as the latter, a TN-mode liquid crystal cell is preferable.

### EXAMPLES

Paragraphs below will further specifically explain the present invention referring to Examples and Comparative Examples, without limiting the present invention. The lubricant compositions in Examples and Comparative Examples were evaluated according to the methods described below.

It is to be noted that the values of Re(55), Rth(550) and the wavelength dispersion characteristics of Re were measured at a wavelength of 550 nm by using an apparatus for measuring birefringence automatically KOBRA-21ADH (by Oji Scientific Instruments) as long as there is no specific description

### Preparation Example 1

### Preparation of Cellulose Acylate Film T1

A cellulose acylate having a total degree of substitution (the degree of acetyl of 0.45 and the degree of propionyl of 2.52) was prepared. Concretely, a mixture of a catalyst, sulfuric acid (in an amount of 7.8 parts by mass relative to 100 parts by mass of cellulose) and a carboxylic acid anhydride was cooled to −20 degrees Celsius, and then added to cellulose derived from pulps. After that, the cellulose was acylated at 40 degrees Celsius. In this, the type and the amount of the carboxylic acid were changed to thereby change and control the type of the acyl group and the degree of substitution with the acyl group. After the acylation, the product was aged at 40 degrees Celsius for controlling the total degree of substitution.

### <Preparation of Cellulose Acylate Solution>

### 1) Cellulose Acylate

The prepared cellulose acylate was dried under heat at 120 degrees Celsius so that the water content ratio thereof was 0.5% by mass or less, and then 30 parts by mass of the cellulose acylate was mixed with a solvent.

### 2) Solvent

As a solvent, a mixture of dichloromethane/methanol/butanol (81/15/4 parts by mass) was used. All of the water content ratios of these solvents were 0.2% by mass or less.

### 3) Additive

When all of the solutions were prepared, 0.9 parts by mass of trimethylol propane triacetate was added to them. And when all of the solutions were prepared, 0.25 parts by mass of fine particles of silica dioxide (particle size, 20 nm; Mohs hardness, about 7) was added to them.

### 4) Swelling, Dissolution

The solvent and the additive mentioned above and 3.0% of UV absorber A shown below were put into a 400-liter stainless solution tank, which has stirring blades and is cooled with cooling water that runs around its periphery. With stirring and dispersing them therein, the cellulose acylate was gradually added to the tank. After the addition, this was stirred at room temperature for 2 hours. After thus swollen for 3 hours, this was again stirred to obtain a cellulose acylate solution.

For the stirring, used were a dissolver-type eccentric stirring shaft that runs at a peripheral speed of 15 m/sec (shear stress, 5×10⁴ kgf/m/sec²) and a stirring shaft that has an anchor blade at the center axis thereof and runs at a peripheral speed of 1 m/sec (shear stress, 1×10⁴ kgf/m/sec²). For the swelling, the high-speed stirring shaft was stopped and the peripheral speed of the anchor blade-having stirring shaft was reduced to 0.5 m/sec.

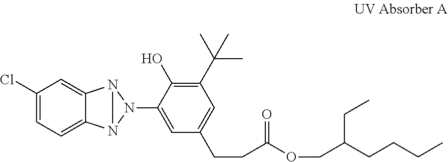

### 5) Filtration

The thus-obtained cellulose acylate solution was filtered through a paper filter sheet (#63, by Toyo Filter) having an absolute filtration accuracy of 0.01 mm and then through a sintered metal filter sheet (FH025, by Paul) having an absolute filtration accuracy of 2.5 micro meters to obtain a polymer solution.

### <Preparation of Cellulose Acylate Film>

The cellulose acylate solution was heated at 30 degrees Celsius, passed through a casting die (described in JP-A-11-314233), and cast onto a mirror-faced stainless support having a band length of 60 m and set at 15 degrees Celsius, at a casting speed of 15 m/min. The casting width was 200 cm. The space temperature in the entire casting zone was set at 15 degrees Celsius. At 50 cm before the endpoint of the casting zone, the cellulose acylate film thus cast and rolled was peeled off from the band, and exposed to drying air applied thereto at 45 degrees Celsius. Next, this was dried at 110 degrees Celsius for 5 minutes and then at 140 degrees Celsius for 10 minutes to obtain a cellulose acylate film T1.

Re (550) and Rth(550) of the cellulose acylate film T1 were −1 nm and −20 nm respectively.

### Preparation Example 2

### Preparation of Cellulose Acylate Film T2

The following ingredients were put into a mixing tank and stirred under heat to dissolve the ingredients, thereby preparing a cellulose acetate solution (dope A) of which the concentration of the solid content solid was 22% by mass.

Formulation of Cellulose Acetate Solution

| | |
|---|---|
| Cellulose acetate having a degree of acetylation | 100.0 mas. pts. |
| of 60.71 to 61.1% | |
| Triphenyl phosphate (Plasticizer) | 7.8 mas. pts. |
| Biphenyl diphenyl phosphate (Plasticizer) | 3.9 mas. pts. |
| Ultraviolet absorber (TINUVIN 328 manufactured | 1.8 mas. pts. |
| by Ciba Specialty Chemicals) | |
| Ultraviolet absorber (TINUVIN 326 manufactured | 0.4 mas. pts. |
| by Ciba Specialty Chemicals) | |
| Methylene chloride (first solvent) | 336 mas. pts. |
| Methanol (second solvent) | 29 mas. pts. |
| 1-butanol (third solvent) | 11 mas. pts. |

Silica fine particles having a mean particle size of 16 nm (AEROSIL R972 manufactured by Nippon Aerosil) were added to the prepared dope A in an amount of 0.02 parts by mass with respect to 100 parts by mass of the cellulose acetate to give a dope B containing the matting agent. The solvent formulation of the dope B was same as that of the dope A, and the concentration of the solid content thereof was 19% by mass.

The dopes A and B were cast onto a band by using a band-stretching machine so that the main stream was formed of the dope A and the upper and lower layers were formed of the dope B containing the matting agent was upper and lower layers cast After the temperature of the film-surface was 40 degrees Celsius, the film was dried under a hot air of 70 degrees Celsius for a minute, then peeled away from the band, dried under a dry air of 140 degrees Celsius for 10 minutes to give a cellulose acylate film T2 having an amount of the residual solvent of 0.3% by mass. The flow rates were adjusted so that the thicknesses of the upper and lower layers were 3 micro meters respectively and the thickness of the main layer was 37 micro meters.

The width of the long cellulose acylate film T2 was 2300 mm and the thickness thereof was 43 micro meters. Re (550) and Rth(550) thereof were 1 nm and 20 nm respectively.

### Preparation Example 3

### Preparation of Cellulose Acylate Film T3

A solution (dope) was prepared by mixing 120 parts by mass of cellulose acetate having the mean acetylation degree of 59.7%, 9.36 parts by mass of triphenylphosphate, 4.68 parts by mass of biphenyl diphenyl phosphate, 1.00 part by mass of retardation enhancer (A), 543.14 parts by mass of methylene chloride, 99.35 parts by mass of methanol and 19.87 parts by mass of n-butanol at a room temperature.

The dope was cast onto a glass substrate, dried at a room temperature for a minute and then dried at 45 degrees Celsius for 5 minutes. The cellulose acylate film was peeled away from the glass substrate, and then dried at 120 degrees Celsius for 10 minutes. The film was cut into a film having an appropriate shape, and then the cut film was stretched along the direction parallel to the casting direction at a temperature of 130 degrees Celsius. During the stretching, the film was allowed to shrink freely along the direction orthogonal to the casting direction. After the stretching, the film as it was dried at 120 degrees Celsius for 30 minutes, and then the stretched film was taken out. The amount of the residual solvent contained in the film was 0.1% by mass. In this way, the cellulose acylate film T3 was obtained.

### Preparation Example 4

### Preparation of Cellulose Acylate Film T4

The following ingredients were put into a mixing tank, mixed at 30 degrees Celsius under being stirred, and dissolved so as to give a cellulose acetate solution (dope A for core layer and dope for outer layer).

| Formulation of Cellulose acetate solution | | |
|---|---|---|
| (parts by mass) | Core layer | Outer layer |
| Cellulose acetate having a degree of | 100 | 100 |
| acetylation of 60.9% | | |
| Triphenyl phosphate (plasticizer) | 7.8 | 7.8 |
| Biphenyl diphenyl phosphate (Plasticizer) | 3.9 | 3.9 |
| Ultraviolet absorber (TINUVIN 328 | 2.7 | 0 |
| manufactured by Ciba Specialty Chemicals) | | |
| Ultraviolet absorber (TINUVIN 326 | 0.6 | 0 |
| manufactured by Ciba Specialty Chemicals) | | |
| Methylene chloride (first solvent) | 293 | 314 |
| Methanol (second solvent) | 71 | 76 |
| 1-butanol (third solvent) | 1.5 | 1.6 |
| Silica fine particles | 0 | 0.8 |
| (AEROSIL R972 manufactured by Nippon Aerosil) | | |
| Retardation enhancer (A) show below | 1.7 | 0 |

Retardation enhancer (A)

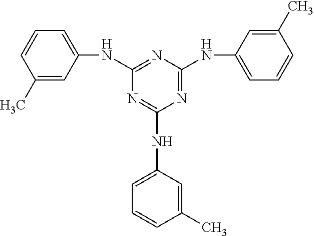

The obtained dope A for core layer and the obtained dope B for outer layer were cast onto a drum cooled at 0 degree Celsius by using a co-casting machine for three layered lamination. The obtained film was peeled off while a solvent content in the film was maintained 70% by mass, held at both width-wise edges thereof with a pin tenter, dried at 80 degrees Celsius while a draw ratio in the machine direction was kept 110%, and then dried at 110 degrees Celsius when the solvent content was reduced to 10% by mass. Thereafter, the film was further dried at 140 degrees Celsius for 30 minutes, and a cellulose acetate film T4 (thickness: 56 micro meters (outer layer: 3 micro meters, core layer 50 micro meters, outer layer: 3 micro meters)) was obtained Re(550) and Rth(550) thereof were 1 nm and 65 nm respectively.

### Preparation Example 5

### Preparation of Cellulose Acylate Film T5

A cellulose acylate film T5 having a thickness of 77 micro meters was prepared in the same manner as the cellulose acylate film T4, except that an amount of the ultraviolet absorber (TINUVIN 328 manufactured by Ciba Specialty Chemicals) was changed to 1.8 parts by mass, an amount of the ultraviolet absorber (TINUVIN 326 manufactured by Ciba Specialty Chemicals) was changed to 0.4 parts by mass and the flow rate for the core layer was adjusted so that the thickness thereof was 71 micro meters. Re(550) and Rth(550) thereof were 2 nm and 95 nm respectively.

### Preparation Example 6

### Preparation of Cellulose Acylate Film T6

A cellulose acylate film T6 was prepared in the same manner as the cellulose acylate film T1, except that the flow rate was adjusted so as to adjust the thickness. Re(550) and Rth(550) thereof were 0 nm and −25 nm respectively.

### Preparation Example 7

### Preparation of Cellulose Acylate Film T7

A cellulose acylate film T7 was prepared in the same manner as the cellulose acylate film T1, except that the flow rate was adjusted so as to adjust the thickness. Re(550) and Rth(550) thereof were 1 nm and −45 nm respectively.

### Preparation Example 8

### Preparation of Cellulose Acylate Film T8

A cellulose acylate film T8 was prepared in the same manner as the cellulose acylate film T2, except that the flow rate was adjusted so as to adjust the thickness. Re(550) and Rth(550) thereof were 1 nm and 25 nm respectively.

### Preparation Example 9

### Preparation of Cellulose Acylate Film T9

A cellulose acylate film T9 was prepared in the same manner as the cellulose acylate film T1, except that an amount of the UV absorber A was changed to 3.0% from 1.2%, and 11% of Rth reducer B shown below was added. Re(550) and Rth(550) thereof were 1 nm and −1 nm respectively.

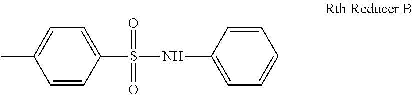

### 1. Preparation of Protective Member

### (Preparation of Protective Member 1)

### <Preparation of λ/4 Film 1>

The surface of the cellulose acylate film T7 was saponified by an alkali solution, a coating liquid for having the following formulation an alignment layer was applied to the saponified surface of the film in an amount of 20 ml/m² by a wire-bar. The coating liquid was dried by a hot air of 60 degrees Celsius for 60 seconds and further dried by a hot air of 100 degrees Celsius for 120 seconds to form a layer. The layer was subjected to a rubbing treatment along the direction of 45° with respect to the long axis of the cellulose acylate film T7. In this way, an alignment layer was prepared.

Formulation of Coating Liquid for Alignment Layer

| | |
|---|---|
| Modified polyvinyl alcohol | 10 parts by mass |
| Water | 371 parts by mass |
| Methanol | 119 parts by mass |
| Glutaraldehyde | 0.5 parts by mass |

Modified polyvinyl alcohol

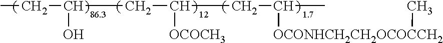

Next, a coating liquid having the following formulation for an optically anisotropic layer was applied to the rubbed surface of the alignment layer by a wire-bar.

Formulation of Coating Liquid for Optically Anisotropic Layer

| | |
|---|---|
| Rod-like liquid crystal compound shown below | 1.8 g |
| Ethylene oxide modified trimethylol propane triacrylate (V#360, manufactured by OSAKA ORGANIC CHEMICAL INDUSTRY LTD.) | 0.2 g |
| Photo-polymerization initiator (Irgacure 907, by Ciba Specialty Chemicals) | 0.06 g |
| Sensitizer (Kayacure DETX, by Nippon Kayaku) | 0.02 g |
| Methyl ethyl ketone | 3.9 g |

Rod-like liquid crystal compound

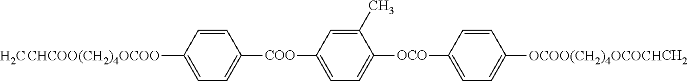

The applied coating liquid was heated in a thermostat chamber at 125 degrees Celsius for 3 minutes. The layer was irradiated with UV ray by using a 120 W/cm-high pressure mercury so as to carry out cross-linking of the rod-like liquid crystal compound. The temperature during the UV-irradiation was 80 degrees Celsius. The thickness of the optically anisotropic layer was 2.0 micro meters. And then, the layer was cooled to a room temperature. In this way, the optically anisotropic layer was formed on the cellulose acylate film T7, and λ/4 film 1 was prepared. The condition of the optically anisotropic layer was evaluated, and any unevenness in the coating (the unevenness caused by repelling the coating liquid by the alignment layer) and any alignment-disorder were not found in the layer.

### <Preparation of Surface Layer (Anti-Reflective Layer)>

### <<Preparation of Coating Liquid for Hard Coat Layer>>

The following ingredients were put into a mixing tank, mixed under being stirred, and filtrated with a filter made of polypropylene having a pore diameter of 0.4 micro meters, to give a coating liquid for a hard coat layer (surface of solid content 58% by mass).

Formulation of Coating Liquid for Hard Coat Layer

| | |
|---|---|
| Methyl acetate | 36.2 parts by mass |
| Methyl ethyl ketone | 36.2 parts by mass |
| (a) Monomer: PETA having the following | 77.0 parts by mass |
| structure (SHIN-NAKAMURA CHEMICAL | |
| CO. LTD.) | |
| (b) Urethane monomer having the following | 20.0 parts by mass |
| structure | |
| Photo-polymerization Initiator*1 | 3.0 parts by mass |
| Leveling agent having the following structure | 0.02 parts by mass |
| (SP-13) | |

*1Irgacure 184, by Ciba Specialty Chemicals

PETA: weight-averaged molecular weight: 325, the number of the functional group in a molecule: 3.5 (the averaged number)

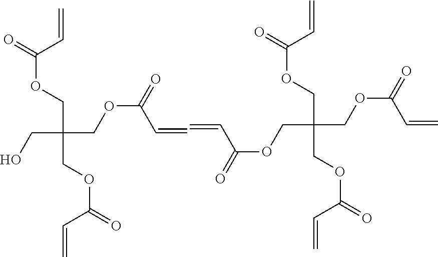

Urethane monomer: weight-averaged molecular weight: 596, the number of the functional group in a molecule: 4 (the averaged number)

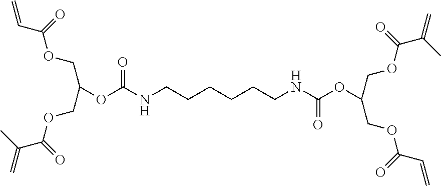

### Leveling Agent (SP-13)

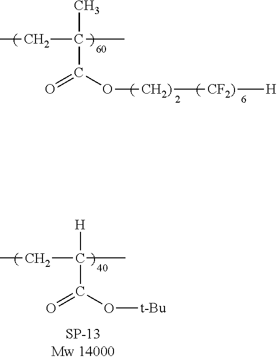

### <<Preparation of Coating Liquid for Low-Refractive Index Layer>>

The following ingredients were dissolved in a mixture of MEK/MMPG-Ac (=85/15 (ratio by mass) according to the following formulation, to give a coating liquid for a low refractive index layer having the solid content of 5% by mass. MEK means methyl ethyl ketone, and MMPG-Ac means propylene glycol monomethyl ether acetate.

Formulation of Coating Liquid for Low-Refractive Index Layer

| | |
|---|---|
| Perfluoroolefin copolymer shown below | 15 parts by mass |
| DPHA*¹ (a mixture of dipentaerythritol | 7 parts by mass |
| pentaacrylate and dipentaerythritol hexaacrylate | |
| mixture available from Nippon Kayaku) | |
| Defensor MCF-323*² | 5 parts by mass |
| Fluorine-containing polymerizable compound | 20 parts by mass |
| shown below | |
| Solid content of hollow silica particles*³ | 50 parts by mass |
| IRGACURE 127*⁴ | 3 parts by mass |

*¹DPHA: a mixture of dipentaerythritol pentaacrylate and dipentaerythritol hexaacrylate mixture available from Nippon Kayaku
*²Defensor MCF-323: Fluorochemical surfactant, available from Dai-Nippon Ink
*³Hollow silica: Hollow silica microparticle dispersing Liquid (mean particle size: 45 nm; refractive index: 1.25; with the surface subjected to a surface treatment by a silane coupling agent having acryloyl group; the concentration of MEK dispersion liquid: 20%)
*⁴IRGACURE 127: Photo-polymerization initiator by Ciba Specialty Chemicals

### Perfluoroolefin Copolymer

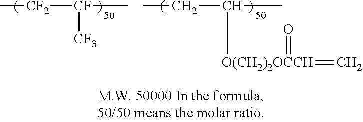

### Fluorine-Containing Polymerizable Compound

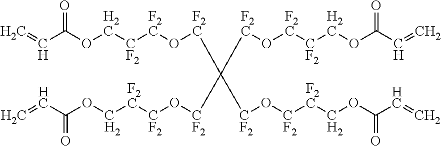

<<Preparation of Hard Coat Layer and Low-Refractive Index Layer>>

The coating liquid for a hard coat layer was applied to the surface of the λ/4 film 1, on which no layer containing the liquid crystal compound was formed, by using a wire bar (an amount of the coated solid content: 12 g/m²) to form a layer. After drying at 100 degrees Celsius for 60 seconds, and then UV-rays at an irradiation dose of 150 mJ/cm² and an illuminance of 400 mW/cm² were irradiated under an atmosphere with a concentration of oxygen of 0.1 vol. % by using an air-cooled metal halide lamp (manufactured by I Graphics Co.) at 160 W/cm to cure the coated layer, and a λ/4 film 1 having a hard coat layer thereon was prepared.

The coating liquid for a low-refractive index layer was applied to the surface of the hard coat layer to give a protective member 1. Drying of the low-refractive index layer was carried out at 70 degrees Celsius for 60 seconds; and irradiation of UV-rays was carried out at an irradiation dose of 300 mJ/cm² and an illuminance of 600 mW/cm² under an atmosphere with a concentration of oxygen of 0.1 vol. % by using an air-cooled metal halide lamp (manufactured by I Graphics Co.) at 240 W/cm.

The refractive index of the low-refractive index layer was 1.34, and the thickness thereof was 95 nm. Re(550) and Rth(550) of the protective member 1 were 138 nm and 25 nm respectively. Re of the protective member 1 showed the normal wavelength dispersion characteristics.

### (Preparation of Protective Member 2)

### <Preparation of λ/4 Film 2>

A λ/4 film 2 was prepared in the same manner as the λ/4 film 1, except that the cellulose acylate film T9 was used in place of the cellulose acylate film T7. Re(550) and Rth(550) of the λ/4 film 2 were 138 nm and 66 nm respectively. Re of the λ/4 film 2 showed the normal wavelength dispersion characteristics.

### <Preparation of Surface Layer (Anti-Reflective Layer) and Protective Member 2>

A protective member 2 was prepared in the same manner as the protective member 1, except that the cellulose acylate film T9 was used in place of the cellulose acylate film T7. Re(550) and Rth(550) of the protective member 2 were 138 nm and 66 nm respectively. Re of the protective member 2 showed the normal wavelength dispersion characteristics.

### (Preparation of Protective Member 3)

A hard coat layer and a low-refractive layer were formed on the cellulose acylate film T3 in the same manner as the protective member 1. The obtained film was rotated by 45 degrees, and was cut to give a protective member 3. The stretching ratio was 42%. The thickness of the obtained film was 97 micro meters, and Re(550) and Rth(550) of thereof were 138 nm and 85 nm respectively. Re of the protective member 2 showed the reversed wavelength dispersion characteristics.

It is also possible to prepare a λ/4 film having a slow axis along the 45 degrees-direction relative to the machine direction by carrying out stretching along the oblique direction.

### (Preparation of Protective Member 4)

### <Preparation of λ/4 Film 4>

A commercially-available norbornene-base polymer film “ZEONOR ZF14” (manufacture by OPTES INC.) was subjected to a monoaxially-free end stretching treatment with a stretching ratio of 45% at a temperature of 156 degrees Celsius to give a norbornene-base λ/4 film 4. Re(550) and Rth(550) of the λ/4 film 4 were 138 nm and 85 nm respectively. Re of the λ/4 film 4 showed the flat wavelength dispersion characteristics.

### <Preparation of Surface Layer (Anti-Reflective Layer) and Protective Member 4>

A hard coat layer and a low-refractive layer were formed on the cellulose acylate film T9 in the same manner as the protective member 1; and the λ/4-film 4 and the cellulose acylate film T9 were bonded to each other via an easily-adhesive layer to give a protective member 4. Re(550) and Rth(550) of the protective member 4 were 138 nm and 85 nm respectively. Re of the protective member 4 showed the flat wavelength dispersion characteristics.

### <Preparation of λ/4 Film 4A>

The λ/4-film 4 and the cellulose acylate film T9 were bonded to each other via an easily-adhesive layer to give a λ/4-film 4A. Re(550) and Rth(550) of the λ/4-film 4A were 138 nm and 85 nm respectively. Re of the λ/4-film 4A showed the flat wavelength dispersion characteristics.

### (Preparation of Protective Member 5)

### <Preparation of λ/4 Film 5>

A λ/4 film 5 was prepared in the same manner as the λ/4 film 1, except that the cellulose acylate film T4 was used in place of the cellulose acylate film T7.

### <Preparation of Surface Layer (Anti-Reflective Layer) and Protective Member 5>

A hard coat layer and a low-refractive layer were formed on the cellulose acylate film T9 in the same manner as the protective member 1; and the surface of the optically anisotropic layer containing the rod-like liquid crystal compound of the λ/4-film 5 and the cellulose acylate film T9 were bonded to each other via an easily-adhesive layer to give a protective member 5. Re(550) and Rth(550) of the protective member 5 were 138 nm and 132 nm respectively. Re of the protective member 5 showed the normal wavelength dispersion characteristics.

### (Preparation of Protective Member 6)

A protective member 6 was prepared in the same manner as the protective member 5, except that the cellulose acylate T5 was used in place of the cellulose acylate film T4. Re(550) and Rth(550) of the protective member 6 were 138 nm and 160 nm respectively. Re of the protective member 6 showed the normal wavelength dispersion characteristics.

### (Preparation of Protective Member 7)

### <Preparation of λ/4 Film 7>

A λ/4 film 7 was prepared in the same manner as the λ/4 film 1, except that a lamination of two cellulose acylate films T6 was used in place of the cellulose acylate film T7.

### <Preparation of Surface Layer (Anti-Reflective Layer) and Protective Member 7>

A hard coat layer and a low-refractive layer were formed on the lamination in the same manner as the protective member 1 to give a protective member 7. Re(550) and Rth(550) of the protective member 7 were 138 nm and 21 nm respectively. Re of the protective member 7 showed the normal wavelength dispersion characteristics.

### (Preparation of Protective Member 8)

### <Preparation of λ/4 Film 8>

The cellulose acylate film T7 was led to pass through a dielectric heating roll at a temperature of 60 degrees Celsius so that the film surface temperature was elevated up to 40 degrees Celsius, and then, using a bar coater, an alkali solution having the composition mentioned below was applied to it in an amount of 14 ml/m²; thereafter this was kept staying below a steam-type far-infrared heater (by Noritake Company) heated at 110 degrees Celsius for 10 seconds, and then also using a bar coater, pure water was applied thereto in an amount of 3 ml/m². In this stage, the film temperature was 40 degrees Celsius. Next, this was washed with water using a fountain coater and treated with an air knife for water removal, repeatedly three times each, and then dried in a drying zone at 70 degrees Celsius for 10 seconds. In this way, a saponified cellulose acylate film was prepared.

Formulation of Alkali Solution for Saponification (parts by mass)

| | | |
|---|---|---|
| Potassium hydroxide | 4.7 | mas. pts. |
| Water | 15.8 | mas. pts. |
| Isopropanol | 63.7 | mas. pts. |
| Surfactant SF-1: C₁₄H₂₉O(CH₂CH₂O)₂₀H | 1.0 | mas. pt. |
| Propylene glycol | 14.8 | mas. pts. |

### <<Preparation of Alignment Layer>>

A coating liquid having the following formulation for an alignment layer was applied to the saponified surface of the saponified cellulose acylate film by using a No. 14 wire bar, and dried with a hot air of 60 degrees Celsius for 60 minutes and with a hot air of 100 degrees Celsius for 120 minutes, to form a layer.

<Formulation of Composition for Alignment Layer >

| | |
|---|---|
| Modified polyvinyl alcohol shown below | 10 parts by mass |
| Water | 317 parts by mass |
| Methanol | 119 parts by mass |
| Glutaraldehyde | 0.5 parts by mass |
| Photo-polymerization initiator (IRGACURE 2959, manufactured by Ciba | 0.3 parts by mass |
| Specialty Chemicals) | |

Modified polyvinyl alcohol

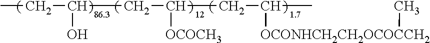

### <Optically Anisotropic Layer Containing Discotic Liquid Crystal Compound>

The alignment layer was subjected to a rubbing treatment continuously. The long direction of the long film was parallel to the machine direction and the rotation axis of the rubbing roll was 45° in the clockwise direction relative to the long direction of the long film.

A coating liquid A having the following formulation was applied to the rubbed surface of the alignment layer by a wire bar continuously. The conveying speed (V) of the film was 36 m/min. For drying the solvent in the coating liquid and aging the alignment of the discotic liquid crystal compound, the coated layer was heated by a hot air at 120 degrees Celsius for 90 seconds. Subsequently, the layer was irradiated with UV-rays at 80 degrees Celsius to fix the alignment of the liquid crystal compound, and an optically anisotropic layer having a thickness of 1.77 micro meters was prepared. In this way, a λ/4 film 8 was prepared.

<Coating Liquid (A) for Optically Anisotropic Layer>

| | |
|---|---|
| Discotic liquid crystal showed below | 91 parts by mass |
| Acrylate monomer^{*1} | 5 parts by mass |
| Photo-polymerization initiator (Irgacure 907, by Ciba Specialty Chemicals) | 3 parts by mass |
| Sensitizer (Kayacure DETX, by Nippon Kayaku) | 1 part by mass |
| Pyridinium salt shown below | 0.5 parts by mass |
| Fluorine-series polymer (FP1) | 0.2 parts by mass |
| Fluorine-series polymer (FP3) | 0.1 parts by mass |
| Methyl ethyl ketone | 189 parts by mass |

^{*1}Ethylene oxide modified trimethylol propane triacrylate (V#360, manufactured by OSAKA ORGANIC CHEMICAL INDUSTRY LTD.) was used as an acrylate monomer.
Discotic liquid crystal 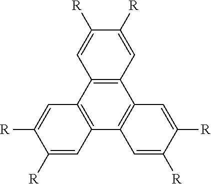 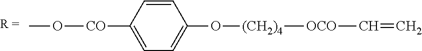
Pyridinium salt 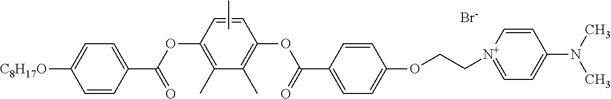
Fluorine-series polymer (FP1) 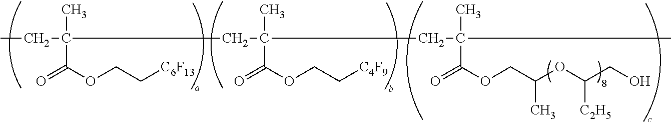
a/b/c = 20/20/60 wt %
Mw = 16000
Fluorine-series polymer (FP3) 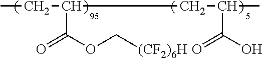
Mw =17000

Re(550) and Rth(550) of the λ/4 film 8 were 138 nm and −91 nm respectively. The slow axis thereof was orthogonal to the rotation axis of the rubbing roll. Namely, the slow axis thereof was 45° in the counterclockwise direction relative to the long axis of the support film. The mean tilt angle of the discotic liquid crystal molecules in the layer relative to the film surface was 90° and it was confirmed that the discotic liquid crystal was applied vertically relative to the film surface.

### <Preparation of Surface Layer (Anti-Reflective Layer) and Protective Member 8>

A protective member 8 was prepared by forming a surface layer (anti-reflective layer) on the surface of the λ/4 film 8, on which no layer containing liquid crystal compound was formed, (on the surface of the cellulose acylate film T7) in the same manner as the protective member 1. Re(550) and Rth(550) of the protective member 8 were 138 nm and −91 nm respectively. Re of the protective member 8 showed the normal wavelength dispersion characteristics.

### (Preparation of Protective Member 9)

### <Preparation of λ/4 Film 9>

A λ/4 film 9 was prepared in the same manner as the λ/4 film 8, except that the cellulose acylate film T2 was used in place of the cellulose acylate film T7.

### <Preparation of Surface Layer (Anti-Reflective Layer) and Protective Member 9>

A protective member 9 was prepared in the same manner as the protective member 8, except that the cellulose acylate film T2 was used in place of the cellulose acylate film T7. Re(550) and Rth(550) of the protective member 9 were 138 nm and −25 nm respectively. Re of the protective member 9 showed the normal wavelength dispersion characteristics.

### (Preparation of Protective Member 10)

A protective member 10 was prepared in the same manner as the protective member 8, except that a cellulose acylate film “TD80UL” (manufactured by FUJIFILM) was used in place of the cellulose acylate film T7. Re(550) and Rth(550) of the protective member 10 were 138 nm and −5 nm respectively. Re of the protective member 10 showed the normal wavelength dispersion characteristics.

### (Preparation of Protective Member 11)

### <Preparation of λ/4 Film 11>

A λ/4 film 11 was prepared in the same manner as the λ/4 film 8, except that the cellulose acylate film T1 was used in place of the cellulose acylate film T7. Re(550) and Rth(550) of the λ/4 film 11 were 138 nm and −64 nm respectively. Re of the λ/4 film 11 showed the normal wavelength dispersion characteristics.

### <Preparation of Surface Layer (Anti-Reflective Layer) and Protective Member 11>

A protective member 11 was prepared in the same manner as the protective member 8, except that the cellulose acylate film T1 was used in place of the cellulose acylate film T7. Re(550) and Rth(550) of the protective member 11 were 138 nm and −64 nm respectively. Re of the protective member 11 showed the normal wavelength dispersion characteristics.

### (Preparation of Protective Member 12)

A protective member 12 was prepared in the same manner as the protective member 8, except that a film prepared by bonding three cellulose acylate films (two cellulose acylate films T7 and a cellulose acylate film T6) via a pressure-sensitive adhesive agent was used in place of the cellulose acylate film T7. Re(550) and Rth(550) of the protective member 12 were 138 nm and −160 nm respectively. Re of the protective member 12 showed the flat wavelength dispersion characteristics.

### (Preparation of Protective Member 13)

A protective member 13 was prepared in the same manner as the protective member 8, except that the cellulose acylate film T8 was used in place of the cellulose acylate film T7. Re(550) and Rth(550) of the protective member 13 were 138 nm and −22 nm respectively. Re of the protective member 13 showed the normal wavelength dispersion characteristics.

### (Preparation of Protective Member 14)

### <Preparation of λ/4 Film 14>

A λ/4 film 14 was prepared in the same manner as the λ/4 film 11, except that the thickness of the optically anisotropic layer was changed to 1.54 micro meters. Re(550) and Rth(550) of the λ/4 film 14 were 120 nm and −53 nm respectively. Re of the λ/4 film 14 showed the normal wavelength dispersion characteristics.

### <Preparation of Surface Layer (Anti-Reflective Layer) and Protective Member 14>

A protective member 14 was prepared by forming a hard coat layer and a low-refractive index layer on the surface of the λ/4 film 14, on which no layer containing liquid crystal compound was formed, (on the surface of the cellulose acylate film T1) in the same manner as the protective member 1. Re(550) and Rth(550) of the protective member 14 were 120 nm and −53 nm respectively. Re of the protective member 14 showed the normal wavelength dispersion characteristics.

### (Preparation of Protective Member 15)

### <Preparation of λ/4 Film 15>

A λ/4 film 15 was prepared in the same manner as the λ/4 film 8, except that the thickness of the optically anisotropic layer was changed to 1.92 micro meters. Re(550) and Rth(550) of the λ/4 film 15 were 150 nm and −97 nm respectively. Re of the λ/4 film 15 showed the normal wavelength dispersion characteristics.

### <Preparation of Surface Layer (Anti-Reflective Layer) and Protective Member 15>

A protective member 15 was prepared by forming a hard coat layer and a low-refractive index layer on the surface of the λ/4 film 15, on which no layer containing liquid crystal compound was formed, (on the surface of the cellulose acylate film T7) in the same manner as the protective member 1. Re(550) and Rth(550) of the protective member 15 were 150 nm and −97 nm respectively. Re of the protective member 15 showed the normal wavelength dispersion characteristics.

### (Preparation of Protective Member 16)

### <Preparation of λ/4 Film 16>

A λ/4 film 16 was prepared in the same manner as the λ/4 film 8, except that the thickness of the optically anisotropic layer was changed to 1.54 micro meters. Re(550) and Rth(550) of the λ/4 film 16 were 120 nm and −82 nm respectively. Re of the λ/4 film 16 showed the normal wavelength dispersion characteristics.

### <Preparation of Surface Layer (Anti-Reflective Layer) and Protective Member 16>

A protective member 16 was prepared by forming a hard coat layer and a low-refractive index layer on the surface of the λ/4 film 16, on which no layer containing liquid crystal compound was formed, (on the surface of the cellulose acylate film T7) in the same manner as the protective member 1. Re(550) and Rth(550) of the protective member 16 were 120 nm and −82 nm respectively. Re of the protective member 16 showed the normal wavelength dispersion characteristics.

### (Preparation of Protective Member 17)

### <Preparation of λ/4 Film 17>

A λ/4 film 17 was prepared in the same manner as the λ/4 film 4, except that the stretching temperature and the stretching ratio were changed respectively. Re(550) and Rth(550) of the λ/4 film 17 were 150 nm and 95 nm respectively. Re of the λ/4 film 17 showed the flat wavelength dispersion characteristics.

### <Preparation of Surface Layer (Anti-Reflective Layer) and Protective Member 17>

A hard coat layer and a low-refractive layer were formed on the cellulose acylate film T9 in the same manner as the protective member 1; and the λ/4-film 17 and the cellulose acylate film T9 were bonded to each other via an easily-adhesive layer to give a protective member 17. Re(550) and Rth(550) of the protective member 17 were 150 nm and 95 nm respectively. Re of the protective member 17 showed the flat wavelength dispersion characteristics.

### <Preparation of λ/4 Film 17A>

The λ/4-film 17 and the cellulose acylate film T9 were bonded to each other via an easily-adhesive layer to give a λ/4-film 17A. Re(550) and Rth(550) of the λ/4-film 17A were 150 nm and 95 nm respectively. Re of the λ/4-film 17A showed the flat wavelength dispersion characteristics.

### (Preparation of Protective Member 18)

### <Preparation of λ/4 Film 18>

A λ/4 film 18 was prepared in the same manner as the λ/4 film 4, except that the stretching temperature and the stretching ratio were changed respectively. Re(550) and Rth(550) of the λ/4 film 18 were 120 nm and 71 nm respectively. Re of the λ/4 film 18 showed the flat wavelength dispersion characteristics.

### <Preparation of Surface Layer (Anti-Reflective Layer) and Protective Member 18>

A hard coat layer and a low-refractive layer were formed on the cellulose acylate film T9 in the same manner as the protective member 1; and the λ/4-film 18 and the cellulose acylate film T9 were bonded to each other via an easily-adhesive layer to give a protective member 18. Re(550) and Rth(550) of the protective member 18 were 120 nm and 71 nm respectively. Re of the protective member 18 showed the flat wavelength dispersion characteristics.

### <Preparation of λ/4 Film 18A>

The λ/4-film 18 and the cellulose acylate film T9 were bonded to each other via an easily-adhesive layer to give a λ/4-film 18A. Re(550) and Rth(550) of the λ/4-film 18A were 120 nm and 71 nm respectively. Re of the λ/4-film 18A showed the flat wavelength dispersion characteristics.

### (Preparation of Protective Member 19)

### <Preparation of λ/4 Film 19>

A λ/4 film 19 was prepared in the same manner as the λ/4 film 2, except that the thickness of the optically anisotropic layer was changed to 1.81 micro meters. Re(550) and Rth(550) of the λ/4 film 19 were 125 nm and 57 nm respectively. Re of the λ/4 film 19 showed the normal wavelength dispersion characteristics.

<Preparation of Surface Layer (Anti-Reflective Layer) and Protective member 19>

A protective member 19 was prepared by forming a hard coat layer and a low-refractive index layer on the surface of the λ/4 film 19, on which no layer containing liquid crystal compound was formed, (on the surface of the cellulose acylate film T9) in the same manner as the protective member 1. Re(550) and Rth(550) of the protective member 19 were 125 nm and 57 nm respectively. Re of the protective member 19 showed the normal wavelength dispersion characteristics.

### (Preparation of Protective Member 20)

### <Preparation of λ/4 Film 20>

The cellulose acylate film T7 was subjected to a saponification treatment in the same manner as the λ/4 film 8, and an alignment layer was formed on the saponified surface thereof in the same manner as the λ/4 film 8. the alignment layer was subjected to a rubbing treatment continuously. During the rubbing treatment, the long axis of the long film was parallel to the conveying direction, and the rotation axis of the rubbing roll was 45° in the clockwise direction relative to the long axis of the film.

A coating liquid B having the following formulation was applied to the rubbed surface of the alignment layer by a wire bar continuously. The conveying speed (V) of the film was 36 m/min. For drying the solvent in the coating liquid and aging the alignment of the discotic liquid crystal compound, the coated layer was heated by a hot air at 120 degrees Celsius for 90 seconds. Subsequently, the layer was irradiated with UV-rays at 80 degrees Celsius to fix the alignment of the liquid crystal compound, and an optically anisotropic layer having a thickness of 0.8 micro meters was prepared. In this way, a λ/4 film 20 was prepared.

<Coating Liquid (B) for Optically Anisotropic Layer>

| | |
|---|---|
| Discotic liquid crystal showed below | 100 parts by mass |
| Photo-polymerization initiator (Irgacure 907, by Ciba Specialty Chemicals) | 3 parts by mass |
| Sensitizer (Kayacure DETX, by Nippon Kayaku) | 1 part by mass |
| Pyridinium salt shown below | 1 part by mass |
| Fluorine-series polymer (FP2) | 0.4 parts by mass |
| Methyl ethyl ketone | 252 parts by mass |

Discotic liquid crystal 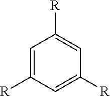 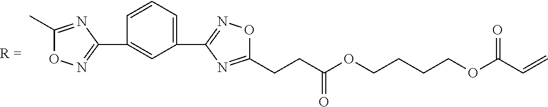
Pyridinium salt 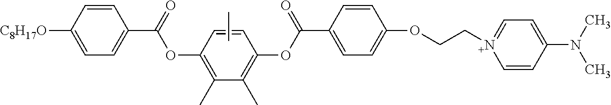 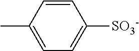
Fluorine-series polymer (FP2) 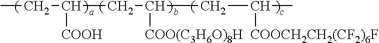
a/b/c = 5/55/40
Mw = 15000

Re(550) and Rth(550) of the λ/4 film 20 were 120 nm and −86 nm respectively. The slow axis thereof was orthogonal to the rotation axis of the rubbing roll. Namely, the slow axis thereof was 45° in the counterclockwise direction relative to the long axis of the support film. The mean tilt angle of the discotic liquid crystal molecules in the layer relative to the film surface was 90° and it was confirmed that the discotic liquid crystal was applied vertically relative to the film surface.

### <Preparation of Surface Layer (Anti-Reflective Layer) and Protective Member 20>

A protective member 20 was prepared by forming a surface layer (anti-reflective layer) on the surface of the λ/4 film 20, on which no layer containing liquid crystal compound was formed, (on the surface of the cellulose acylate film T7) in the same manner as the protective member 1. Re(550) and Rth(550) of the protective member 20 were 120 nm and −86 nm respectively. Re of the protective member 20 showed the normal wavelength dispersion characteristics.

### <Preparation of λ/4 Film 20>

### (Preparation of λ/4 Plate)

The norbornene-base λ/4 film 4 was rotated by 45 degrees and was cut into an appropriate shape to give a λ/4 plate 1. Re(550) and Rth(550) of the λ/4 plate 1 were 138 nm and 85 nm respectively. Re of the λ/4 plate 1 showed the flat wavelength dispersion characteristics.

The data such as retardation of each of the protective members were shown in the following table.

TABLE 1

| Protective | | | Wave- | |
|---|---|---|---|---|
| Member | Re(550) | Rth(550) | length | Lamination state of |
| No. | (nm) | (nm) | dispersion | Protective member*1 |
| 1 | 138 | 25 | Normal | */RLC/T7/HC/L |
| 2 | 138 | 66 | Normal | */RLC/T9/HC/L |
| 3 | 138 | 85 | Reversed | */T3/HC/L |
| 4 | 138 | 85 | Flat | */λ/4 Film 4/T9/HC/L |
| 5 | 138 | 132 | Normal | */T4/RLC/T9/HC/L |
| 6 | 138 | 160 | Normal | */T5/RLC/T9/HC/L |
| 7 | 138 | 21 | Normal | */RLC/T6/T6/HC/L |
| 8 | 138 | −91 | Normal | */DLC/T7/HC/L |
| 9 | 138 | −25 | Normal | */DLC/T2/HC/L |
| 10 | 138 | −5 | Normal | */DLC/TD80UL/HC/L |
| 11 | 138 | −64 | Normal | */DLC/T1/HC/L |
| 12 | 138 | −160 | Normal | */DLC/T7/T7/T6/HC/L |
| 13 | 138 | −22 | Normal | */DLC/T8/HC/L |
| 14 | 120 | −53 | Normal | */DLC/T1/HC/L |
| 15 | 150 | −97 | Normal | */DLC/T7/HC/L |
| 16 | 120 | −82 | Normal | */DLC/T7/HC/L |
| 17 | 150 | 95 | Flat | */λ/4 Film 4/T9/HC/L |
| 18 | 120 | 71 | Flat | */λ/4 Film 4/T9/HC/L |
| 19 | 125 | 57 | Normal | */RLC/T9/HC/L |
| 20 | 120 | −86 | Normal | */DLC/T7/HC/L |
| λ/4 plate 1 | 138 | 85 | Flat | — |

In the table, “*” means the first polarizing film; “HC” means the hard coat layer; and “L” means the low-refractive index layer.
In the table, “T1-T9” mean cellulose acylate films “T1-T9” respectively.
In the Table, “RLC” means the rod-like liquid crystal compound, and “DLC” means the discotic liquid crystal compound.

### 2. Preparation of Polarizing Plate

A polyvinyl alcohol (PVA) film having a thickness of 80 μm was dyed by dipping it in an aqueous iodine solution having an iodine concentration of 0.05% by mass at 30 degrees Celsius for 60 seconds, then stretched in the machine direction by 5 times the original length while dipped in an aqueous boric acid solution having a boric acid concentration of 4% by mass for 60 seconds, and thereafter dried at 50 degrees Celsius for 4 minutes to give a polarizing film having a thickness of 20 μm.

A commercially available film “WV-EA” manufactured by FUJIFILM was prepared and subjected to a saponification treatment. The polarizing film was bonded to the saponified film “WV-EA” and any one selected from the protective members 1-20 or the λ/4 films 1-20 via a pressure-sensitive adhesive agent so that the saponified film “WV-EA” was disposed on a surface of the polarizing film and the protective member or the λ/4 film was disposed on another surface of the polarizing film.

A commercially available film “TD80UL” manufactured by FUJIFILM was prepared and subjected to a saponification treatment. The polarizing film was bonded to the saponified film “TD80UL” and the λ/4 plate 1 via a pressure-sensitive adhesive agent so that the saponified film “TD80UL” was disposed on a surface of the polarizing film and the λ/4 plate 1 was disposed on another surface of the polarizing film. In this way, a polarizing plate A to be used for a liquid crystal cell shutter was prepared.

### 3. Fabrication of 3D Display System

### (Fabrication of Liquid Crystal Display Device)

The front polarizing plate was removed from a TN-mode liquid crystal monitor “E2420HD” manufactured by BenQ Corporation, and each of the polarizing plates shown in the following tables was bonded to the visual surface so that the absorption axis and the slow axis were adjusted as shown in the following tables and the protective member was disposed at the visual surface side. In this way, each of the liquid crystal display devices was fabricated.

### (Fabrication of Liquid Crystal Shutter Eyeglasses)

Two liquid crystal shutter eyeglasses of “Olympus Power3D Media Player with 3D-Glasswere” (manufactured by OLYMPUS VISUAL COMMUNICATIONS CORPORATION) were prepared, and the polarizing plates disposed at the visual surface side were removed from them. The polarizing plate A was bonded to one of them so that the λ/4 plate 1 was disposed at the visual surface side to give a polarizing plate bis-type eyeglasses as shown in FIG. 2; and the λ/4 plate 1 was bonded to another of them to give a polarizing plate mono-type eyeglasses as shown in FIG. 3(A). When being bonded to the eyeglasses, the polarizing plate A or the λ/4 plate 1 was disposed so that the slow axis of the λ/4 plate 1 in the eyeglasses disposed in the frontal direction of the liquid crystal display device was orthogonal to the slow axis of the protective member in the liquid crystal display device

### 4. Referential Examples

Liquid crystal display devices of referential examples 1-12 were fabricated respectively as follows.

### (Preparation of Polarizing Plate)

A polyvinyl alcohol (PVA) film having a thickness of 80 μm was dyed by dipping it in an aqueous iodine solution having an iodine concentration of 0.05% by mass at 30 degrees Celsius for 60 seconds, then stretched in the machine direction by 5 times the original length while dipped in an aqueous boric acid solution having a boric acid concentration of 4% by mass for 60 seconds, and thereafter dried at 50 degrees Celsius for 4 minutes to give a polarizing film having a thickness of 20 μm.

A retardation film for VA mode (manufactured by FUJIFILM; Re(550)=50 nm; Rth(550)=125 nm) was subjected to a saponification treatment; and the polarizing film was bonded to the saponified film for VA-mode and any one selected from the protective members 1, 4, 6, 8, 9 and 10 via a pressure-sensitive adhesive agent or an adhesive agent so that the saponified film for VA-mode was disposed on a surface of the polarizing film and the protective member was disposed on another surface of the polarizing film. In this way, each of polarizing plates was prepared.

### (Fabrication of Liquid Crystal Display Device)

The front polarizing plate was removed from a 3D liquid crystal television “LC-46LV3” manufactured by SHARP, and each of the polarizing plates shown in the following tables was bonded to the visual surface so that the absorption axis and the slow axis were adjusted as shown in the following tables and the protective member was disposed at the visual surface side. In this way, each of the liquid crystal display devices was fabricated.

### (Fabrication of Liquid Crystal Shutter Eyeglasses)

Two liquid crystal shutter eyeglasses “AN-3DG10” manufactured by SHARP were prepared, and the polarizing plates disposed at the visual surface side were removed from them. The polarizing plate A was bonded to one of them so that the λ/4 plate 1 was disposed at the visual surface side to give a polarizing plate bis-type eyeglasses; and the λ/4 plate 1 was bonded to another of them to give a polarizing plate mono-type eyeglasses. When being bonded to the eyeglasses, the polarizing plate A or the λ/4 plate 1 was disposed so that the slow axis of the λ/4 plate 1 in the eyeglasses disposed in the frontal direction of the liquid crystal display device was orthogonal to the slow axis of the protective member in the liquid crystal display device

### 5. Evaluations

Each of the liquid crystal displays was allowed to be in the 3D-displaying state; one of the eyeglasses was allowed to be in the white state and another of the eyeglasses was allowed to be in the black state. Under this condition, a measuring apparatus (“BM-5A” manufactured by TOPCON CORPORATION) was disposed at the position where the light went through the eyeglass in the white state, and the variation in the coloration in the glass-rotating-state in the white state was measured as follows. The results were shown in the following tables.

### (Evaluation of Variation of Coloration in White State at Viewing Angle in Horizontal Direction)

The evaluation of the variation of coloration in the white state at the viewing angle in the horizontal direction was carried out as follows. The variation of v′ was calculated on the basis of the maximum and minimum of v′ (the color tone in the white state) measured in each of 10 directions defined by a polar angle of 60 degrees and an azimuth angle of 0, 20, 40, 140, 160, 180, 200, 220, 320 and 340 degrees respectively; and on the basis of the total value of the v′-variation obtained at each of the 10 directions, the evaluation was carried out in accordance with the following criteria.

AA: The total of the variations of v′ in the white state was less than 0.05 (any coloration was not recognized at all in each of the directions, which was acceptable).

A: The total of the variations of V in the white state was not less than 0.05 and less than 0.10 (a minimal coloration was recognized in one or more of the directions, which was acceptable).

B: The total of the variations of V in the white state was not less than 0.10 and less than 0.15 (any coloration was recognized in one or more of the directions, which was acceptable).

C: The total of the variations of V in the white state was not less than 0.15 (an intense coloration was recognized in one or more of the directions, which was not acceptable).

### (Evaluation of Variation of Coloration in White State at Viewing Angle in Vertical Direction)

The evaluation of the variation of coloration in the white state at the viewing angle in the vertical direction was carried out as follows. The variation of v′ was calculated on the basis of the maximum and minimum of v′ (the color tone in the white state) measured in each of 5 directions defined by a polar angle of 60 degrees and an azimuth angle of 50, 70, 90, 110 and 130 degrees respectively; and on the basis of the total value of the v′-variation obtained at each of the 5 directions, the evaluation was carried out in accordance with the following criteria.

AA: The total of the variations of v′ in the white state was less than 0.025 (any coloration was not recognized at all in each of the directions, which was acceptable).

A: The total of the variations of V in the white state was not less than 0.025 and less than 0.05 (a minimal coloration was recognized in one or more of the directions, which was acceptable).

B: The total of the variations of V in the white state was not less than 0.05 and less than 0.075 (any coloration was recognized in one or more of the directions, which was acceptable).

C: The total of the variations of V in the white state was not less than 0.075 (an intense coloration was recognized in one or more of the directions, which was not acceptable).

### (Evaluation of Variation of Coloration in White State at Viewing Angle in Oblique Direction)

The evaluation of the variation of coloration in the white state at the viewing angle in the oblique direction was carried out as follows. The variation of v′ was calculated on the basis of the maximum and minimum of v′ (the color tone in the white state) measured in each of 2 directions defined by a polar angle of 60 degrees and an azimuth angle of 45 and 135 degrees respectively; and on the basis of one v′-variation value larger than another, the evaluation was carried out in accordance with the following criteria.

AA: The variation of V in the white state was less than 0.010 (any coloration was not recognized, which was acceptable).

A: The variation of V in the white state was not less than 0.010 and less than 0.025 (a minimal coloration was recognized, which was acceptable).

B: The variation of V in the white state was not less than 0.025 and less than 0.040 (any coloration was recognized in one or more of the directions, which was acceptable).

C: The variation of V in the white state was not less than 0.040 (an intense coloration was recognized, which was not acceptable).

TABLE 2

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| First | Protective | No. | 1 | λ/ | 2 | λ/ | 19 | λ/ | 3 | 4 | λ/ | 17 |
| Polar- | Member | | | 4-Film 1 | | 4-Film 2 | | 4-Film 19 | | | 4-Film 4 | |
| izing | | Re(550) (nm) | 138 | 138 | 138 | 138 | 125 | 125 | 138 | 138 | 138 | 150 |
| Plate | | Rth(550) (nm) | 25 | 25 | 66 | 66 | 57 | 57 | 85 | 85 | 85 | 95 |
| | | Angle of | 0 | 0 | 0 | 0 | 0 | 0 | 0 | 0 | 0 | 0 |
| | | Slow Axis (°) | | | | | | | | | | |
| | First | Angle of | 45 | 45 | 45 | 45 | 45 | 45 | 45 | 45 | 45 | 45 |
| | Polarizing | Absorption | | | | | | | | | | |
| | Film | Axis (°) | | | | | | | | | | |

| | | | | | | | | | | | |
|---|---|---|---|---|---|---|---|---|---|---|---|
| Evalu- | Horizontal direction | B | B | AA | AA | AA | AA | B | AA | AA | AA |
| ation | Vertical direction | — | — | — | — | — | — | — | — | — | — |
| | Oblique direction | AA | AA | AA | AA | AA | AA | AA | AA | AA | AA |

TABLE 3

| | | | | | | | | Com- | | | | |
|---|---|---|---|---|---|---|---|---|---|---|---|---|
| | | | Exam- | Exam- | Exam- | Exam- | Exam- | parative | Exam- | Exam- | Exam- | Exam- |
| | | | ple 11 | ple 12 | ple 13 | ple 14 | ple 15 | Example 1 | ple 16 | ple 17 | ple 18 | ple 19 |
| First | Protective | No. | λ/ | 18 | λ/ | 5 | 6 | 7 | 8 | λ/ | 15 | λ/ |
| Polar- | Member | | 4-Film 17A | | 4-Film 18A | | | | | 4-Film 8 | | 4-Film 15 |
| izing | | Re(550) (nm) | 150 | 120 | 120 | 138 | 138 | 138 | 138 | 138 | 150 | 150 |
| Plate | | Rth(550) (nm) | 95 | 71 | 71 | 132 | 160 | 21 | −91 | −91 | −97 | −97 |
| | | Angle of | 0 | 0 | 0 | 0 | 0 | 0 | 0 | 0 | 0 | 0 |
| | | Slow Axis (°) | | | | | | | | | | |
| | First | Angle of | | | | | | | | | | |
| | Polarizing | Absorption | 45 | 45 | 45 | 45 | 45 | 45 | 45 | 45 | 45 | 45 |
| | Film | Axis (°) | | | | | | | | | | |

| | | | | | | | | | | | |
|---|---|---|---|---|---|---|---|---|---|---|---|
| Evalu- | Horizontal direction | AA | AA | AA | A | B | C | — | — | — | — |
| ation | Vertical direction | — | — | — | — | — | C | AA | AA | AA | AA |
| | Oblique direction | AA | AA | AA | AA | AA | AA | AA | AA | AA | AA |

TABLE 4

| | | | | | | | | | Com- | | | |
|---|---|---|---|---|---|---|---|---|---|---|---|---|
| | | | Exam- | Exam- | Exam- | Exam- | Exam- | Exam- | parative | Exam- | Exam- | Exam- |
| | | | ple 20 | ple 21 | ple 22 | ple 23 | ple 24 | ple 25 | Example 2 | ple 26 | ple 27 | ple 28 |
| First | Protective | No. | 16 | λ/ | 20 | λ/ | 9 | λ/ | 10 | 9 | 11 | λ/ |
| Polar- | Member | | | 4-Film 16 | | 4-Film 20 | | 4-Film 9 | | | | 4-Film 11 |
| izing | | Re(550) (nm) | 120 | 120 | 120 | 120 | 138 | 138 | 138 | 138 | 138 | 138 |
| Plate | | Rth(550) (nm) | −82 | −82 | −86 | −86 | −25 | −25 | −5 | −25 | −64 | −64 |
| | | Angle of | 0 | 0 | 0 | 0 | 0 | 0 | 0 | 90 | 90 | 90 |
| | | Slow Axis (°) | | | | | | | | | | |
| | First | Angle of | 45 | 45 | 45 | 45 | 45 | 45 | 45 | 45 | 45 | 45 |
| | Polarizing | Absorption | | | | | | | | | | |
| | Film | Axis (°) | | | | | | | | | | |

| | | | | | | | | | | | |
|---|---|---|---|---|---|---|---|---|---|---|---|
| Evalu- | Horizontal direction | — | — | — | — | — | — | C | B | AA | AA |
| ation | Vertical direction | AA | AA | AA | AA | B | B | C | — | — | — |
| | Oblique direction | AA | AA | AA | AA | AA | AA | AA | AA | AA | AA |

TABLE 5

| | | | Exam- | Exam- | Exam- | Exam- | Comparative | Comparative | Exam- | Exam- |
|---|---|---|---|---|---|---|---|---|---|---|
| | | | ple 29 | ple 30 | ple 31 | ple 32 | Example 3 | Example 4 | ple 33 | ple 34 |
| First | Protective | No. | 14 | λ/4-Film 14 | 8 | 12 | 13 | 10 | 4 | λ/4-Film 4A |
| Polar- | Member | Re(550) (nm) | 120 | 120 | 138 | 138 | 138 | 138 | 138 | 138 |
| izing | | Rth(550) (nm) | −53 | −53 | −91 | −160 | −22 | −5 | 85 | 85 |
| Plate | | Angle of | 90 | 90 | 90 | 90 | 90 | 90 | 90 | 90 |
| | | Slow Axis (°) | | | | | | | | |
| | First | Angle of | 45 | 45 | 45 | 45 | 45 | 45 | 45 | 45 |
| | Polarizing | Absorption | | | | | | | | |
| | Film | Axis (°) | | | | | | | | |

| | | | | | | | | | |
|---|---|---|---|---|---|---|---|---|---|
| Evalu- | Horizontal direction | AA | AA | AA | B | C | C | — | AA |
| ation | Vertical direction | — | — | — | — | C | C | AA | — |
| | Oblique direction | AA | AA | AA | AA | AA | AA | AA | AA |

TABLE 6

| | | | Example | Example | Example | Example | Example |
|---|---|---|---|---|---|---|---|
| | | | 35 | 36 | 37 | 38 | 39 |
| First | Protective | No. | 17 | λ/4-Film 17A | 18 | λ/4-Film 18A | 1 |
| Polar- | Member | Re(550) (nm) | 150 | 150 | 120 | 120 | 138 |
| izing | | Rth(550) (nm) | 95 | 95 | 71 | 71 | 25 |
| Plate | | Angle of | 90 | 90 | 90 | 90 | 90 |
| | | Slow Axis (°) | | | | | |
| | First | Angle of | 45 | 45 | 45 | 45 | 45 |
| | Polarizing | Absorption | | | | | |
| | Film | Axis (°) | | | | | |

| | | | | | | |
|---|---|---|---|---|---|---|
| Evalu- | Horizontal direction | AA | AA | AA | AA | — |
| ation | Vertical direction | — | — | — | — | B |
| | Oblique direction | AA | AA | AA | AA | AA |

TABLE 7

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 40 | ple 41 | ple 42 | ple 43 | ple 44 | ple 45 | ple 46 | ple 47 | ple 48 | ple 49 |
| First | Protective | No. | 1 | λ/4-Film 1 | 2 | λ/4-Film 2 | 19 | λ/4-Film 19 | 3 | 4 | λ/4-Film 4 | 17 |
| Polar- | Member | Re(550) (nm) | 138 | 138 | 138 | 138 | 125 | 125 | 138 | 138 | 138 | 150 |
| izing | | Rth(550) (nm) | 25 | 25 | 66 | 66 | 57 | 57 | 85 | 85 | 85 | 95 |
| Plate | | Angle of | 0 | 0 | 0 | 0 | 0 | 0 | 0 | 0 | 0 | 0 |
| | | Slow Axis (°) | | | | | | | | | | |
| | First | Angle of | 135 | 135 | 135 | 135 | 135 | 135 | 135 | 135 | 135 | 135 |
| | Polarizing | Absorption | | | | | | | | | | |
| | Film | Axis (°) | | | | | | | | | | |

| | | | | | | | | | | | |
|---|---|---|---|---|---|---|---|---|---|---|---|
| Evalu- | Horizontal direction | B | B | AA | AA | AA | AA | B | AA | AA | AA |
| ation | Vertical direction | — | — | — | — | — | — | — | — | — | — |
| | Oblique direction | AA | AA | AA | AA | AA | AA | AA | AA | AA | AA |

TABLE 8

| | | | | | | | | Com- | | | | |
|---|---|---|---|---|---|---|---|---|---|---|---|---|
| | | | Exam- | Exam- | Exam- | Exam- | Exam- | parative | Exam- | Exam- | Exam- | Exam- |
| | | | ple 50 | ple 51 | ple 52 | ple 53 | ple 54 | Example 5 | ple 55 | ple 56 | ple 57 | ple 58 |
| First | Protective | No. | λ/ | 18 | λ/ | 5 | 6 | 7 | 8 | λ/ | 15 | λ/ |
| Polar- | Member | | 4-Film 17A | | 4-Film 18A | | | | | 4-Film 8 | | 4-Film 15 |
| izing | | Re(550) (nm) | 150 | 120 | 120 | 138 | 138 | 138 | 138 | 138 | 150 | 150 |
| Plate | | Rth(550) (nm) | 95 | 71 | 71 | 132 | 160 | 21 | −91 | −91 | −97 | −97 |
| | | Angle of | 0 | 0 | 0 | 0 | 0 | 0 | 0 | 0 | 0 | 0 |
| | | Slow Axis (°) | | | | | | | | | | |
| | First | Angle of | 135 | 135 | 135 | 135 | 135 | 135 | 135 | 135 | 135 | 135 |
| | Polarizing | Absorption | | | | | | | | | | |
| | Film | Axis (°) | | | | | | | | | | |

| | | | | | | | | | | | |
|---|---|---|---|---|---|---|---|---|---|---|---|
| Evalu- | Horizontal direction | AA | AA | AA | A | B | C | — | — | — | — |
| ation | Vertical direction | — | — | — | — | — | C | AA | AA | AA | AA |
| | Oblique direction | AA | AA | AA | AA | AA | AA | AA | AA | AA | AA |

TABLE 9

| | | | Exam- | Exam- | Exam- | Exam- | Exam- | Exam- | Comparative | Exam- | Exam- | Exam- |
|---|---|---|---|---|---|---|---|---|---|---|---|---|
| | | | ple 59 | ple 60 | ple 61 | ple 62 | ple 63 | ple 64 | Example 6 | ple 65 | ple 66 | ple 67 |
| First | Protective | No. | 16 | λ/ | 20 | λ/ | 9 | λ/ | 10 | 9 | 11 | λ/ |
| Polar- | Member | | | 4-Film16 | | 4-Film 20 | | 4-Film 9 | | | | 4-Film 11 |
| izing | | Re(550) (nm) | 120 | 120 | 120 | 120 | 138 | 138 | 138 | 138 | 138 | 138 |
| Plate | | Rth(550) (nm) | −82 | −82 | −86 | −86 | −25 | −25 | −5 | −25 | −64 | −64 |
| | | Angle of | 0 | 0 | 0 | 0 | 0 | 0 | 0 | 90 | 90 | 90 |
| | | Slow Axis (°) | | | | | | | | | | |
| | First | Angle of | 135 | 135 | 135 | 135 | 135 | 135 | 135 | 135 | 135 | 135 |
| | Polarizing | Absorption | | | | | | | | | | |
| | Film | Axis (°) | | | | | | | | | | |

| | | | | | | | | | | | |
|---|---|---|---|---|---|---|---|---|---|---|---|
| Evalu- | Horizontal direction | — | — | — | — | — | — | C | B | AA | AA |
| ation | Vertical direction | AA | AA | AA | AA | B | B | C | — | — | — |
| | Oblique direction | AA | AA | AA | AA | AA | AA | AA | AA | AA | AA |

TABLE 10

| | | | Exam- | Exam- | Exam- | Exam- | Comparative | Comparative | Exam- | Exam- |
|---|---|---|---|---|---|---|---|---|---|---|
| | | | ple 68 | ple 69 | ple 70 | ple 71 | Example 7 | Example 8 | ple 72 | ple 73 |
| First | Protective | No. | 14 | λ/4-Film 14 | 8 | 12 | 13 | 10 | 4 | λ/4-Film 4A |
| Polar- | Member | Re(550) (nm) | 120 | 120 | 138 | 138 | 138 | 138 | 138 | 138 |
| izing | | Rth(550) (nm) | −53 | −53 | −91 | −160 | −22 | −5 | 85 | 85 |
| Plate | | Angle of | 90 | 90 | 90 | 90 | 90 | 90 | 90 | 90 |
| | | Slow Axis (°) | | | | | | | | |
| | First | Angle of | 135 | 135 | 135 | 135 | 135 | 135 | 135 | 135 |
| | Polarizing | Absorption | | | | | | | | |
| | Film | Axis (°) | | | | | | | | |

| | | | | | | | | | |
|---|---|---|---|---|---|---|---|---|---|
| Evalu- | Horizontal direction | AA | AA | AA | B | C | C | — | AA |
| ation | Vertical direction | — | — | — | — | C | C | AA | — |
| | Oblique direction | AA | AA | AA | AA | AA | AA | AA | AA |

TABLE 11

| | | | Example | Example | Example | Example | Example |
|---|---|---|---|---|---|---|---|
| | | | 74 | 75 | 76 | 77 | 78 |
| First | Protective | No. | 17 | λ/4-Film17A | 18 | λ/4-Film 18A | 1 |
| Polar- | Member | Re(550) (nm) | 150 | 150 | 120 | 120 | 138 |
| izing | | Rth(550) (nm) | 95 | 95 | 71 | 71 | 25 |
| Plate | | Angle of | 90 | 90 | 90 | 90 | 90 |
| | | Slow Axis (°) | | | | | |
| | First | Angle of | 135 | 135 | 135 | 135 | 135 |
| | Polarizing | Absorption | | | | | |
| | Film | Axis (°) | | | | | |

| | | | | | | |
|---|---|---|---|---|---|---|
| Evalu- | Horizontal direction | AA | AA | AA | AA | — |
| ation | Vertical direction | — | — | — | — | B |
| | Oblique direction | AA | AA | AA | AA | AA |

TABLE 12

| | | | Referential | Referential | Referential | Referential | Referential | Referential |
|---|---|---|---|---|---|---|---|---|
| | | | Example 1 | Example 2 | Example 3 | Example 4 | Example 5 | Example 6 |
| First | Protective | No. | 1 | 4 | 6 | 9 | 10 | 8 |
| Polar- | Member | Re(550) (nm) | 138 | 138 | 138 | 138 | 138 | 138 |
| izing | | Rth(550) (nm) | 25 | 85 | 160 | −25 | −5 | −91 |
| Plate | | Angle of | 135 | 135 | 135 | 135 | 135 | 135 |
| | | Slow Axis (°) | | | | | | |
| | First | Angle of | 0 | 0 | 0 | 0 | 0 | 0 |
| | Polarizing | Absorption | | | | | | |
| | Film | Axis (°) | | | | | | |

| | | | | | | | |
|---|---|---|---|---|---|---|---|
| Evalu- | Horizontal direction | AA | AA | AA | AA | AA | AA |
| ation | Vertical direction | AA | AA | AA | AA | AA | AA |
| | Oblique direction | A | B | C | A | A | B |

TABLE 13

| | | | Referential | Referential | Referential | Referential | Referential | Referential |
|---|---|---|---|---|---|---|---|---|
| | | | Example 7 | Example 8 | Example 9 | Example 10 | Example 12 | Example 13 |
| First | Protective | No. | 1 | 4 | 6 | 9 | 10 | 8 |
| Polar- | Member | Re(550) (nm) | 138 | 138 | 138 | 138 | 138 | 138 |
| izing | | Rth(550) (nm) | 25 | 85 | 160 | −25 | −5 | −91 |
| Plate | | Angle of | 45 | 45 | 45 | 45 | 45 | 45 |
| | | Slow Axis (°) | | | | | | |
| | First | Angle of | 0 | 0 | 0 | 0 | 0 | 0 |
| | Polarizing | Absorption | | | | | | |
| | Film | Axis (°) | | | | | | |

| | | | | | | | |
|---|---|---|---|---|---|---|---|
| Evalu- | Horizontal direction | AA | AA | AA | AA | AA | AA |
| ation | Vertical direction | AA | AA | AA | AA | AA | AA |
| | Oblique direction | A | B | C | A | A | B |

From the data shown in the tables, it is understandable that the variations of coloration in the horizontal, vertical and oblique directions were reduced by disposing the first polarizing film so that the absorption axis thereof was 45° or 135° with respect to the horizontal direction of the visual surface, disposing the protective member so that the slow axis thereof was 0° or 90° with respect to the horizontal direction of the visual surface and using the protective film having Rth(550) satisfying the condition of the above-described relation (I).

The same results were obtained in the evaluations of the 3D display devices respectively which were fabricated in the same manner as the above-described examples and comparative examples respectively, except that the polarizing plate mono-type eyeglasses as shown in FIG. 3(A) were used in place of the polarizing plate bis-type eyeglasses as shown in FIG. 2.

The same results were obtained in the evaluations of the 3D display devices respectively which were fabricated in the same manner as the above-described examples and comparative examples respectively, except that an OCB-mode or ECB-mode liquid crystal cell was used in place of the TN-mode liquid crystal cell.

The same results were obtained in the evaluations of the 3D display devices respectively which were fabricated in the same manner as the above-described examples and comparative examples respectively, except that a low-reflective film “Clear AR” (manufactured by Sony Chemicals & Information Device Corporation) or a film of preventing of reflection “AGA1” manufactured by SANRITS CORPORATION was used in place of the optical film.

A 3D display system shown in FIG. 7 was fabricated, and the same result was obtained in the evaluations thereof performed in the same manner as the above-described examples and comparative examples.

1. A 3D display device comprising:
a first polarizing film disposed at an observer-side, and
a protective member, having a λ/4-function, disposed on an observer-side surface of the first polarizing film, wherein
the first polarizing film is disposed so that an absorption axis thereof is along a direction of 45° or 135° with respect to a horizontal direction of a visual surface,
the protective member is disposed so that a slow axis thereof is along a direction of 0° or 90° with respect to the horizontal direction of the visual surface, and
an absolute value of retardation along the thickness direction at a wavelength of 550 nm, Rth(550), of the protective member satisfies the following relation (I):
25 nm≦|Rth(550)|160 nm. (I)

2. The 3D display device of claim 1, wherein the protective member is disposed so that the slow axis thereof is along a direction of 0° with respect to the horizontal direction of the visual surface, and Rth(550) of the protective member satisfies the following relation (Ia):
25 nm≦Rth(550)≦160 nm. (Ia)

3. The 3D display device of claim 1, wherein the protective member is disposed so that the slow axis thereof is along a direction of 90° with respect to the horizontal direction of the visual surface, and Rth(550) of the protective member satisfies the following relation (Ib):
−160 nm≦Rth(550)≦−25 nm. (Ib)

4. The 3D display device of claim 1, wherein the protective member comprises a retardation layer formed of a composition comprising a liquid crystal compound.

5. The 3D display device of claim 4, wherein the liquid crystal compound is a discotic liquid crystal compound, and the discotic liquid crystal compound is aligned vertically in the retardation layer.

6. The 3D display device of claim 4, wherein the liquid crystal compound is a rod-like liquid crystal compound, and the rod-like liquid crystal compound is aligned horizontally in the retardation layer.

7. The 3D display device of claim 1, wherein retardation in-plane of the protective member as a whole is constant without any dependency on a wavelength in a visible light region or has normal wavelength dispersion characteristics in a visible light region.

8. The 3D display device of claim 1, wherein the protective member comprises an antireflective layer disposed at an observer-side surface thereof.

9. The 3D display device of claim 1, wherein the protective member comprises an ultraviolet absorber.

10. The 3D display device of claim 1, comprising a liquid crystal cell employing a TN-mode, OCB mode or ECB mode.

11. An alternate-frame sequencing manner 3D displaying system comprising:
an alternate-frame sequencing manner 3D display device of claim 1, and
an alternate-frame sequencing shutter working in synchronization with the 3D display device.

12. The alternate-frame sequencing manner 3D displaying system of claim 11, wherein the alternate-frame sequencing shutter comprises, in the following order from a surface thereof facing the 3D display device,
a λ/4 plate,
a liquid crystal cell and
a polarizing film.

13. The alternate-frame sequencing manner 3D displaying system of claim 12, wherein the alternate-frame sequencing shutter further comprises a polarizing film disposed between the λ/4 plate and the liquid crystal cell.
